(19) United States
(12) Patent Application Publication
(10) Pub. No.: US 2025/0227751 A1
(43) Pub. Date: Jul. 10, 2025

(54) TAG SINGULATION OF PASSIVE RFID TAGS

(71) Applicant: QUALCOMM Incorporated, San Diego, CA (US)

(72) Inventors: Luanxia YANG, Beijing (CN); Piyush GUPTA, Bridgewater, NJ (US); Xiaojie WANG, Hillsborough, NJ (US); Junyi LI, Greentown, PA (US)

(21) Appl. No.: 18/871,142

(22) PCT Filed: Jul. 20, 2022
(86) PCT No.: PCT/CN2022/106629

§ 371 Date: Dec. 2, 2024

(51) Int. Cl. H04W 74/04; H04W 72/566; H04W 74/0833

(52) U.S. Cl. CPC H04W 74/04; H04W 72/566; H04W 74/085

(57) ABSTRACT

Certain aspects of the present disclosure provide techniques for radio frequency identification (RFID) tag singulation. Certain aspects provide a method for wireless communication by a receiver, such as a passive RFID tag. The method generally includes receiving, from a transmitter (e.g., such as a reader), a value for a slot-counter parameter; initializing a slot counter based on the value for the slot-counter parameter; receiving, from the transmitter, a command to adjust the slot counter; adjusting the slot counter based on the command and a step value; and transmitting data to the transmitter via backscatter communication when the adjusted slot counter reaches a target value, wherein at least one of: the step value is greater than one, or initializing the slot counter is further based on a scaling factor.

### BACKGROUND

### Field of the Disclosure

Aspects of the present disclosure relate to wireless communications, and more particularly, to improved techniques for radio frequency identification (RFID) tag singulation.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a receiver. The method includes receiving, from a transmitter, a value for a slot-counter parameter; initializing a slot counter based on the value for the slot-counter parameter; receiving, from the transmitter, a command to adjust the slot counter; adjusting the slot counter based on the command and a step value; and transmitting data to the transmitter via backscatter communication when the adjusted slot counter reaches a target value, wherein at least one of: the step value is greater than one, or initializing the slot counter is further based on a scaling factor.

Another aspect provides a method for wireless communication by a transmitter. The method includes transmitting, to a receiver, a value for a slot-counter parameter; transmitting, to the receiver, a command to adjust a slot counter initialized based on the value for the slot-counter parameter using a step value; and receiving data from the transmitter via backscatter communication when the adjusted slot counter reaches a target value, wherein at least one of: the step value is greater than one, or the slot counter is initialized further based on a scaling factor.

Another aspect provides a method for wireless communication by a receiver. The method includes receiving, from a transmitter, a command comprising information identifying at least one device to transmit data to the transmitter via backscatter communication; and transmitting the data to the transmitter via backscatter communication, when the information identifies the receiver.

Another aspect provides a method for wireless communication by a transmitter. The method includes transmitting, to a receiver, a command comprising information identifying at least one device to transmit data via backscatter communication to the transmitter; and receiving the data from the receiver via backscatter communication, when the information identifies the receiver.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 illustrates a radio frequency identification (RFID) system.

FIG. 6 is a call flow diagram illustrating example signaling between a reader and a passive RFID tag performing an example inventory procedure.

FIGS. 7A and 7B are call flow diagrams illustrating example signaling between a reader and a passive RFID tag performing an example inventory procedure using an increased adjust step.

FIGS. 8A and 8B are call flow diagrams illustrating example signaling between a reader and passive RFID tags performing an example inventory procedure where a range of slot counter values selected by the RFID tags are decreased.

FIGS. 9A and 9B are call flow diagrams illustrating example signaling between a reader and passive RFID tags performing an example inventory procedure where a range of slot counter values selected by the passive RFID tags are different.

FIG. 10 is a call flow diagram illustrating example signaling between a reader and a passive RFID tag performing an example inventory procedure using an explicit indication of the passive RFID tag.

FIG. 11 depicts a method for wireless communications.

FIG. 12 depicts another method for wireless communications.

FIG. 13 depicts another method for wireless communications.

FIG. 14 depicts another method for wireless communications.

FIG. 15 depicts aspects of an example communications device.

FIG. 16 depicts aspects of an example communications device.

### DETAILED DESCRIPTION

Aspects of the present disclosure provide apparatuses, methods, processing systems, and computer-readable mediums for radio frequency identification (RFID) tag singulation, and more specifically, singulation of passive RFID tags.

A new generation of wireless devices may overcome conventional limitations of on-board energy storage by harvesting energy from wireless signals (e.g., radio frequency (RF) signals) to perform wireless communications. Such energy harvesting devices (e.g., user equipments) may include, for example, RFID devices (e.g., RFID tags), that are capable of receiving signals and “backscattering” them to another device to perform wireless communications. These aforementioned devices may generally be passive, in which case they include no on-board energy storage and rely entirely on harvested energy from received signals to perform wireless communications (e.g., via backscattering signals). Thus, energy harvesting devices are a type of user equipment that provides low-cost and low-power solutions for many applications in a wireless communications system.

Singulation is a process by which a unique RFID tag (e.g., passive RFID tag) is isolated (e.g., distinguished) from a population of RFID tags. In particular, a reader (e.g., such as a network entity) may manage RFID tag populations using three operations: (1) selection, (2) inventory, and (3) access. Selection generally refers to a procedure by which the reader selects an RFID tag population for inventory and access. Inventory generally refers to a procedure by which the reader identifies one or more RFID tags from within the population. Further, access generally refers to a procedure by which the reader transacts with (that is, reads from or writes to) an individual tag, that is uniquely identified prior to access (via the inventory procedure). Operations such as selection, inventory, and access may be used for tag singulation.

The reader may begin an inventory procedure with passive RFID tags by broadcasting a Query command. The broadcasted Query command may include a value for a slot counter parameter, Q. Upon receiving the Query command, each passive RFID tag may initialize its slot counter by randomly selecting a number in the range of [0, 2^{Q}−1]. A passive RFID tag which initializes its slot counter to a target value, such as zero, may reply (e.g., via backscatter communication) to the Query command broadcasted by the reader. Although aspects herein use a target value of zero, other target values may be considered.

In some cases, however, when the reader broadcasts a Query command, no passive RFID tag slot counter may reach zero. As such, no RFID tag may backscatter a signal to the reader. Accordingly, the reader may transmit another command.

In some cases, the command transmitted prompts each of the passive RFID tags to adjust the value of the slot counter parameter, Q, based on the command. The command may be referred to as a “QueryAdjust” command. Accordingly, each of the passive RFID tags may adjust the value of Q and randomly select a number in the range of [0, 2^{Q}−1] (e.g., where Q is the newly adjusted Q) as their corresponding slot counter value.

In some other cases, the command transmitted prompts each of the passive RFID tags to decrement their slot counter value (e.g., random number) by one. Each passive RFID tag decrements its slot counter by one whenever receiving the command. The command may be referred to as a “QueryRep” command.

In either of the cases described above, if a passive RFID tag's slot counter reaches zero, that passive RFID tag backscatters a signal to the reader. This procedure continues until at least one passive RFID tag selects a value for their slot counter equal to the target value, and thus, transmits a signal to the reader (e.g., via backscatter communication).

In some cases, multiple iterations of the above procedure may occur prior to a passive RFID tag selecting a value of their slot counter equal to the target value. Thus, the inventory procedure may result in increased signaling overhead and/or decreased resource availability.

Accordingly, aspects of the present disclosure provide different approaches to reduce an amount of resources consumed and/or signaling overhead during the inventory procedure. For example, different approaches described herein may (1) adjust the slot counter value using a step value greater than one, (2) decrease a slot counter value range used by a passive RFID tag to initialize a value of the slot counter, (3) initialize a slot counter by randomly selecting a value for the slot counter using a weighted distribution, and/or (4) explicitly indicating which passive RFID tag(s) are to transmit a signal via backscatter communication. As such, using one or more of the approaches described herein, a probability of an RFID tag's slot counter reaching a target value (e.g., zero) may be increased. Accordingly, a number of iterations needed prior to a value of the slot counter reaching the target value (e.g., zero) may be reduced, thereby reducing an amount of resources consumed, as well as the signaling overhead needed to perform the inventory procedure.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

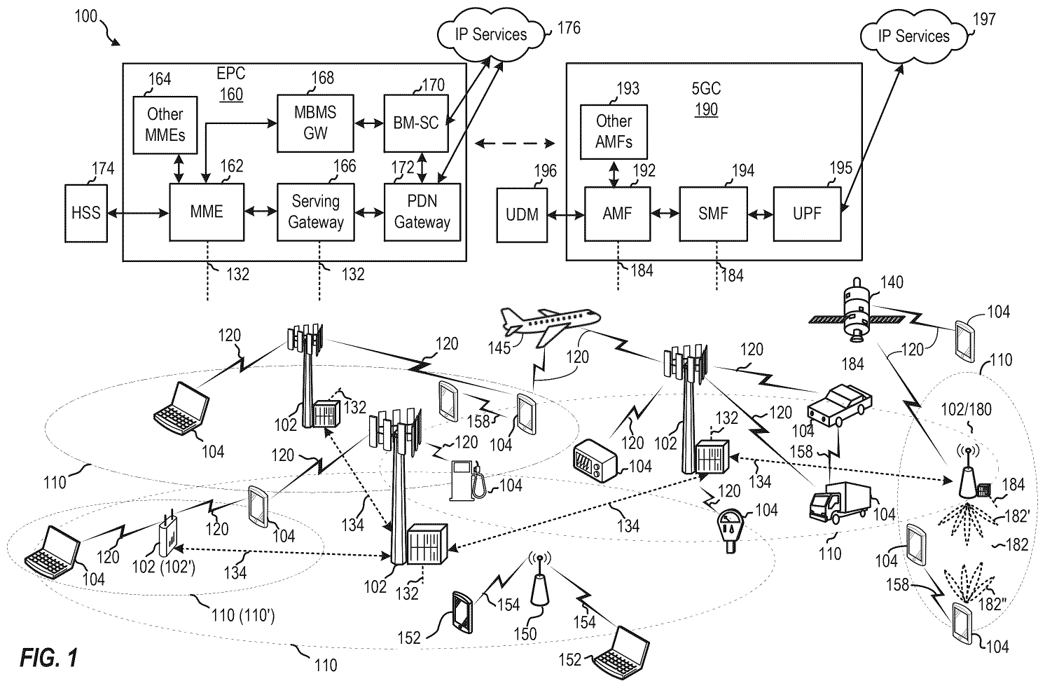

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

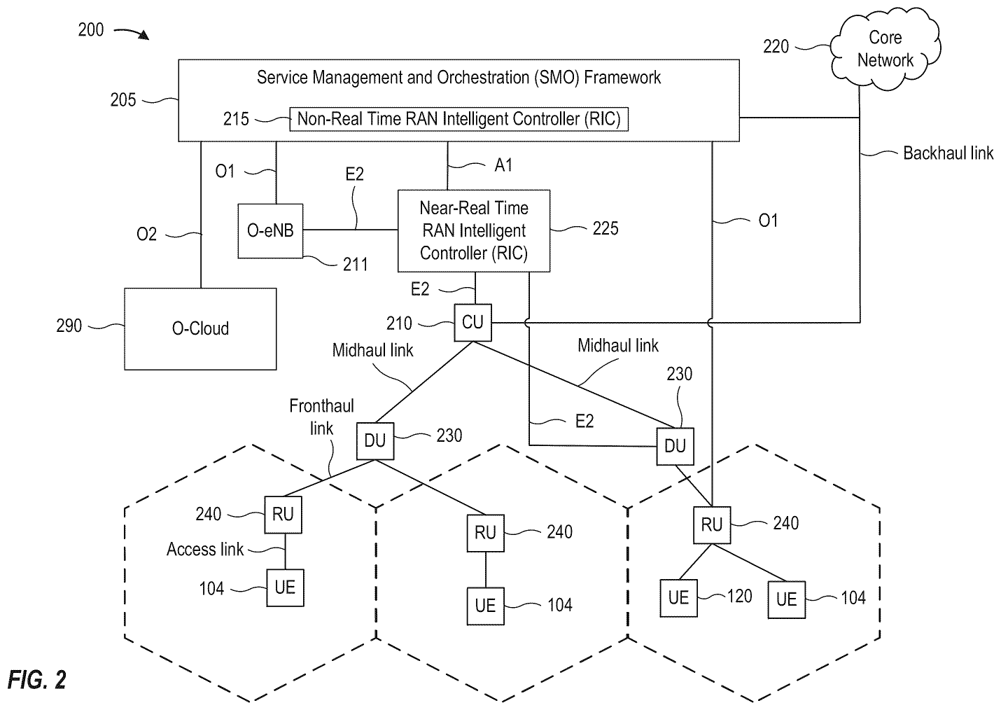

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHZ, which is sometimes referred to (interchangeably) as a “millimeter wave” (“mmW” or “mm Wave”). A base station configured to communicate using mmWave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

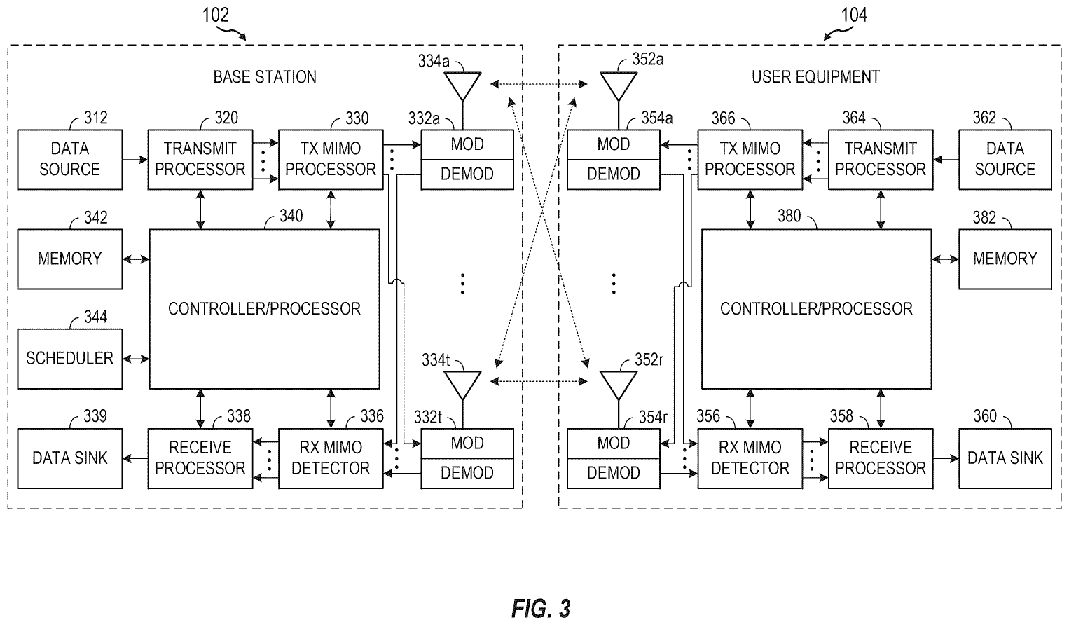

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

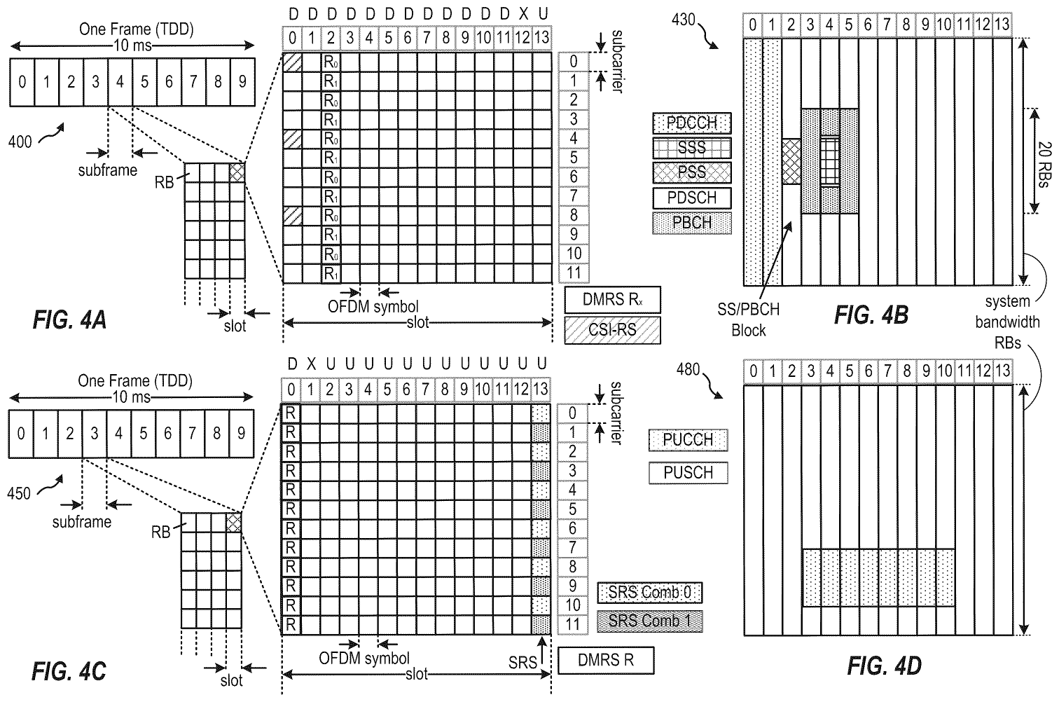

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 24× 15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to Energy Harvesting in RFID Systems

Radio frequency identification (RFID) is a rapidly growing technology impacting many industries due to its economic potential for inventory/asset management within warehouses, internet of things (IoT), sustainable sensor networks in factories and/or agriculture, and smart homes, to name a few example applications. RFID technology consists of RFID devices (or backscatter devices), such as transponders, or tags, that emit an information-bearing signal upon receiving an energizing signal.

In certain aspects, RFID devices may be operated without a battery. Generally, RFID devices that are operated without a battery are known as passive RFID devices. Passive RFID devices may operate by harvesting energy from received radio frequency signals (e.g., “over the air”), thereby powering reception and transmission circuitry within the RFID devices. This harvested energy allows passive RFID devices to transmit information, sometimes referred to as backscatter modulated information, without the need for a local power source within the RFID device. On the other hand, in certain aspects, RFID device may be semi-passive and include on-board energy storage to supplement their ability to harvest energy from received signals (however, at higher cost).

In certain aspects, in addition to harvesting power from RF sources, energy harvesting devices may accumulate energy from other direct energy sources, such as solar energy, in order to supplement its power demands. Semi-passive energy harvesting devices may in some cases include power consuming RF components, such as analog to digital converters (ADCs), mixers, and oscillators.

Thus, RFID devices are a type of user equipment that provides a low-cost and low-power solutions for many applications in a wireless communications system. Such devices may be very power efficient, sometimes requiring less than 0.1 mW of power to operate. Further, their relatively simple architectures and, in some cases, lack of battery, mean that such devices can be small, lightweight, and easily installed or integrated in many types of environments or host devices. Generally speaking then, RFID devices provide practical and necessary solutions to many networking applications that require, low-cost, small footprint, durable, maintenance-free, and long lifespan communications devices. For example, RFID devices may be configured as long endurance industrial sensors, which mitigates the problems of replacing batteries in and around dangerous machinery.

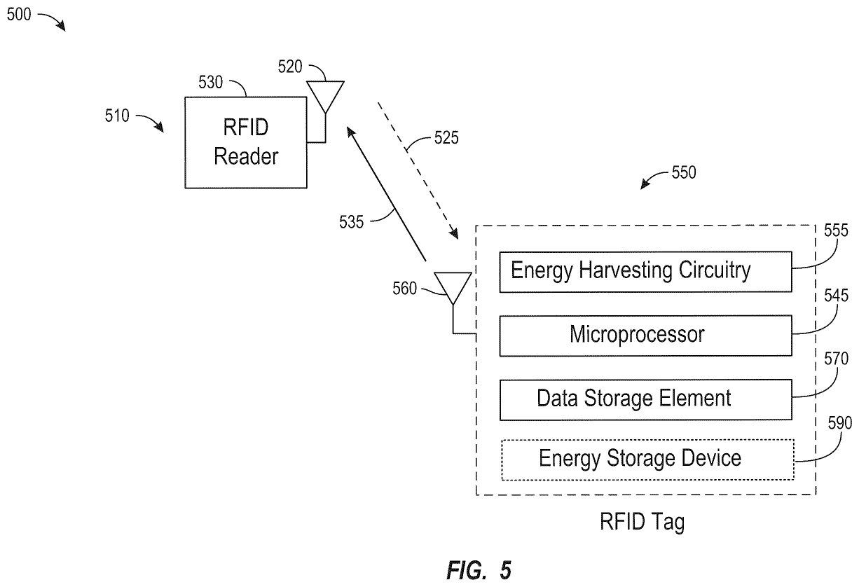

FIG. 5 shows an RFID system 500. As shown, RFID system 500 includes a reader 510 and an RFID tag 550. Reader 510 may also be referred to as an interrogator or a scanner. RFID tag 550 may also be referred to as an interrogator, RFID label, or an electronics label. In certain aspects, reader 510 is a network entity (e.g., such as a gNB) and RFID tag 550 is a user equipment (UE).

Reader 510 includes an antenna 520 and an electronics unit 530. Antenna 520 radiates signals transmitted by reader 510 and receives signals from RFID tags and/or other devices. Electronics unit 530 may include a transmitter and a receiver for reading RFID tags such as RFID tag 550. The same pair of transmitter and receiver (or another pair of transmitter and receiver) may support bi-directional communication with wireless networks, wireless devices, etc. Electronics unit 530 may include processing circuitry (e.g., a processor) to perform processing for data being transmitted and received by the RFID reader 510.

As shown, RFID tag 550 includes an antenna 560 and a data storage element 570. Antenna 560 radiates signals transmitted by RFID tag 550 and receives signals from RFID reader 510 and/or other devices. Data storage element 570 stores information for RFID tag 550, for example, in an electrically erasable programmable read-only memory (EEPROM) or another type of memory. RFID tag 550 may also include an electronics unit that can process the received signal and generate the signals to be transmitted.

In certain aspects, RFID tag 550 may be a passive RFID tag having no battery. In this case, induction may be used to power the RFID tag 550. For example, in some cases, a magnetic field from a signal transmitted by reader 510 may induce an electrical current in RFID tag 550, which may then operate based on the induced current. RFID tag 550 can radiate its signal in response to receiving a signal from RFID reader 510 or some other device. In certain other aspects, RFID tag 550 may optionally include an energy storage device 590, such as a battery, capacitor, etc., for storing energy harvested using energy harvesting circuitry 555, as described below.

In one example, RFID tag 550 may be read by placing the reader 510 within close proximity to RFID tag 550. Reader 510 may radiate a first signal 525 via the antenna 520. In some cases, the first signal 525 may be known as an interrogation signal or energy signal. In some cases, energy of the first signal 525 may be coupled from reader antenna 520 to RFID tag antenna 560 via magnetic coupling and/or other phenomena. In other words, the RFID tag 550 may receive the first signal 525 from reader 510 via antenna 560 and energy of the first signal 525 may be harvested using energy harvesting circuitry 555 (e.g., an RF transducer) and used to power RFID tag 550. For example, energy of the first signal 525 received by RFID tag 550 may be used to power a microprocessor 545 of RFID tag 550. Microprocessor 545 may, in turn, retrieve information stored in a data storage element 570 of RFID tag 550 and transmit the retrieved information via a second signal 535 using the antenna 560. For example, in some cases, microprocessor 545 may generate the second signal 535 by modulating a baseband signal (e.g., generated using energy of the first signal 525) with the information retrieved from the data storage element 570. In some cases, this second signal 535 may be known as a backscatter modulated information signal. Thereafter, as noted, microprocessor 545 transmits the second signal 535 to reader 510. Reader 510 may receive the second signal 535 from RFID tag 550 via antenna 520 and may process (e.g., demodulate) the received signal to obtain the information of data storage element 570 sent in second signal 535.

In some cases, RFID system 500 may be designed to operate at 13.56 MHz or some other frequency (e.g., an ultra-high frequency (UHF) band at 900 MHZ). Reader 510 may have a specified maximum transmit power level, which may be imposed by the Federal Communication Commission (FCC) in the United Stated or other regulatory bodies in other countries. The specified maximum transmit power level of reader 510 may limit the distance at which RFID tag 550 can be read by reader 510.

Wireless technology is increasingly useful in industrial applications, such as ultra-reliable low-latency communication (URLLC) and machine type communication (MTC). In such domains, and others, it is desirable to support devices (e.g., passive RFID tags) that are capable of harvesting energy from wireless energy sources (e.g., in lieu of or in combination with a battery or other energy storage device, such as a capacitor), such as RF signals, thermal energy, solar energy, and the like.

### Aspects Related to Tag Singulation of Passive RFID Tags

Aspects of the present disclosure provide improved techniques for tag singulation of passive radio frequency identification (RFID) tags. As noted above, singulation is a process by which a unique RFID tag is isolated (e.g., distinguished) from a population of RFID tags. In particular, a reader may manage RFID tag populations using three operations: (1) selection, (2) inventory, and (3) access. Selection generally refers to a procedure by which the reader selects an RFID tag population for inventory and access. Inventory generally refers to a procedure by which the reader identifies one or more RFID tags. Further, access refers to a procedure by which the reader transacts with (that is, reads from or writes to) an individual tag, that is uniquely identified prior to access. Operations such as selection, inventory, and access may be used for tag singulation.

With respect to the inventory procedure, a sequence of commands may be sent and received between both a reader and an RFID tag to allow the reader to identify an identifier code of the RFID tag, such as an electronic product code (EPC) of the RFID tag. For example, the reader may begin an inventory procedure by broadcasting a Query command. The broadcasted Query command may include a value for a slot counter parameter, Q, where the value for the slot counter parameter is between zero and fifteen. Upon receiving the Query command, each RFID tag may initialize its slot counter by randomly selecting a number in the range of [0, 2^{Q}−1]. An RFID tag which initializes its slot counter to a value of zero (e.g., randomly selects 0 from [0, 2^{Q}−1]) may reply to the Query command broadcasted by the reader.

In cases where the RFID tag is a passive device, the RFID tag may reply via backscatter communication. Backscatter is method which uses an incident radio frequency RF signal to transmit data without a battery or power source. For example, RFID tag may harvest energy from the Query command (e.g., energy signal) using EH circuitry (such as energy harvesting circuitry 555 illustrated in FIG. 5). The RFID tag may use this harvested energy to (1) power one or more other components of the second device and (2) reflect a signal back to the first device. This type of communication may be known as backscatter communication

In the reply signal to the reader, the RFID may send a 16-bit random number to the reader. At the same time, this RFID tag may transition to a Reply state, while the other RFID tags transition to an Arbitrate state. Where the response from the RFID tag is successfully received, the RFID reader may reply by sending an acknowledgement (ACK), together with the same 16-bit random number. This response may then allow the RFID tag to send back its tag ID and/or EPC to the reader.

In some cases, however, when the reader broadcasts the Query command, no RFID tag which receives the signal may select a value of the slot counter equal be zero. As such, no RFID tag may backscatter a signal to the reader. Traditionally, after a (pre) defined period of time has passed without receiving a response from an RFID tag, the reader may transmit a command.

In some cases, the command transmitted prompts each of the passive RFID tags to adjust the value of the slot counter parameter, Q, based on the command. The command may be referred to as a “QueryAdjust” command. Accordingly, each of the passive RFID tags adjust the value of Q and randomly select a number in the range of [0, 2^{Q}−1] (e.g., where Q is the newly adjusted Q) as their corresponding slot counter value when receiving the command.

In some other cases, the command asks each of the RFID tags to decrement their slot counter value (e.g., random number) by one. Accordingly, each passive RFID tag decrements its slot counter by one whenever receiving the command. The command may be referred to as a “QueryRep” command.

This procedure continues until an RFID tag selects a value for their slot counter equal to zero, and thus, transmits a signal to the reader (e.g., via backscatter communication where the RFID tag is a passive RFID device). In some cases, multiple iterations of the above procedure may occur prior to an RFID tag selecting a value of their slot counter equal to zero. In some cases, the procedure may involve the use of both “Query Adjust” and “QueryRep” commands until an RFID tag selects a value for their slot counter equal to zero.

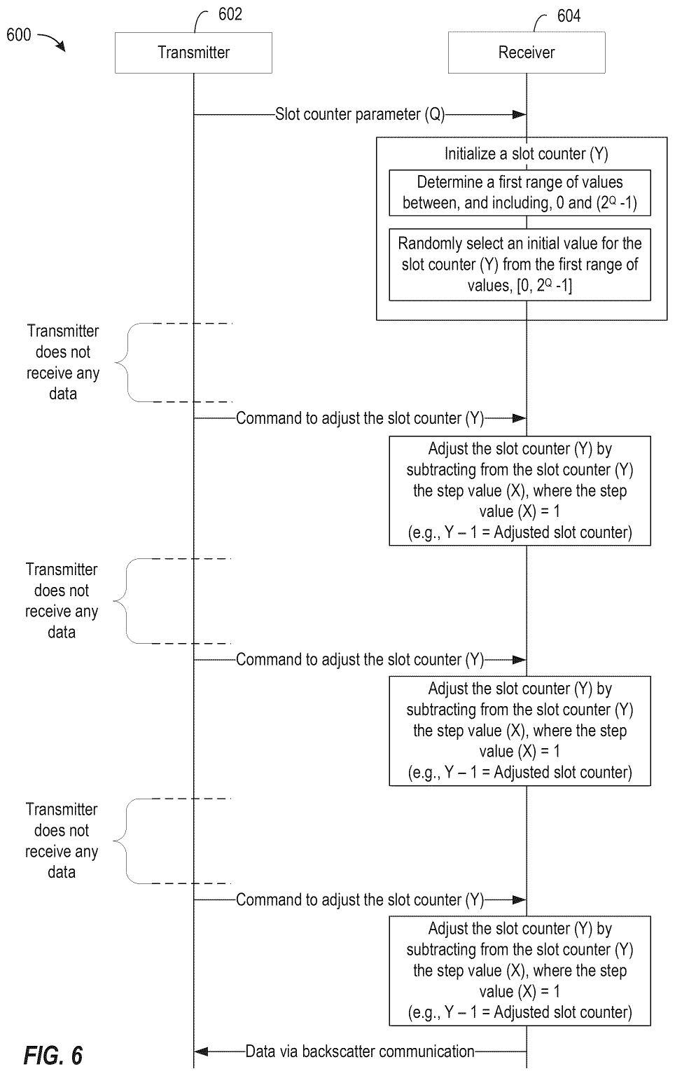

An example procedure, as described above, is illustrated in FIG. 6. In particular, FIG. 6 is a call flow diagram illustrating example signaling 600 between a transmitter 602 and a receiver 604 performing an example inventory procedure. In certain aspects, transmitter 602 is a reader, such as RFID reader 510 illustrated in FIG. 5, and receiver 604 is a passive RFID tag, such as RFID tag 550 (where RFID tag 550 is a passive RFID device) illustrated in FIG. 5. However, in other aspects, transmitter 602 may be another type of wireless communications device (e.g., network entity, network node, etc.), and, similarly, receiver 604 may be another type of wireless communications device (e.g., UE, etc.), such as those described herein. In the example inventory procedure of FIG. 6, three iterations of the above procedure may be performed until a slot counter value of the passive RFID tag equals zero, and thus, may transmit a signal, back to the reader, via backscatter communication.

Though the example inventory procedure illustrated in FIG. 6 illustrates only the use of “QueryRep” commands (e.g., commands prompting each of the passive RFID tags to decrement their slot counter value), in certain embodiments, “QueryAdjust” commands (e.g., commands prompting each of the passive RFID tags to adjust the value of Q and select a new random number in the range of [0, 2^{Q}−1] (e.g., where Q is the newly adjusted Q) as their corresponding slot counter value) may be used as an alternative to the illustrated “QueryRep” commands or in addition to the illustrated “QueryRep” commands.

As shown, the inventory procedure begins by transmitter 602 transmitting a value of a slot counter parameter, Q, via broadcast communication. As mentioned, in certain aspects, the value for the slot counter parameter is between zero and fifteen. One or more receivers 604 (although shown as only one receiver 604 in FIG. 6) may receive the broadcasted slot counter parameter value, and in response, initialize a slot counter value, Y. In certain aspects, initializing a slot counter value Y includes (1) determining a first range of values between, and including zero and 2^{Q}−1 and (2) randomly selecting an initial value for the slot counter, Y, from the first range of values, [0, 2^{Q}−1]. For example, where Q=4, receiver 604 may randomly select an initial value for the slot counter between, and including, [0, 2⁴−1], or [0, 15]. In this example, receiver 604 may randomly select the initial value for the slot counter to be equal to three (e.g., Y=3).

In this example, receiver 604 may select an initial value for the slot counter, Y, not equal to zero. As such, receiver 604 does not backscatter a signal to transmitter 602. Further, in this example, other receivers which receive the broadcasted parameter, Q, also select an initial value for the slot counter, Y, not equal to zero. Accordingly, no receiver, including receiver 604, backscatters a signal to transmitter 602.

Transmitter 602 may wait for a response from a receiver for a (pre) defined amount of time. Where a response is not received from a receiver in a window having the (pre) defined amount of time, transmitter 602 may subsequently transmit a command (e.g., a “QueryRep” command) to adjust a value of the slot counter, Y, by a step value equal to one. More specifically, the command may ask each receiver, including receiver 604, to decrement a value of their slot counter, Y, by one (e.g., Adjusted slot counter, Y_{adjusted}=Y−1). For example, where the previously selected slot counter value equals three, the adjusted slot counter value is equal to two (e.g., Y_{adjusted}=3−1=2).

Again, a value of the slot counter is not equal to zero (e.g., 2≠0), and receiver 604 does not backscatter a signal to transmitter 602. Other receivers, after decrementing a value of their slot counter may also not have a slot counter value equal to zero. Accordingly, transmitter 602 may not receive a response from a receiver in a window having the (pre) defined amount of time.

This process may repeat two more times until a value of the slot counter parameter for receiver 604 is equal to zero. Receiver 604 transmits, to transmitter 602, data via backscatter communication when the slot counter value is equal to zero. This example assumes that for three iterations, no other receiver beyond receiver 604, has a slot counter value equal to zero.

As illustrated, the example inventory procedure illustrated in FIG. 6 may result in increased signaling overhead, as well as, an increase of resources consumed until a slot counter value for receiver 604 is equal to zero. Increased signaling overhead and/or decreased resource availability may result in poor wireless communication.

According to aspects described herein, a first approach to reducing an amount of resources consumed and/or signaling overhead during the inventory procedure involves increasing the step value to be greater than one. As such, instead of decrementing a value of a slot counter by one in response to receiving a command from a reader (e.g., transmitter 602 in FIG. 6) to reduce the value of the slot counter, the value may be reduced by a number larger than one, thereby reducing a number of iterations needed prior to the value of the slot counter reaching a value of zero.

In certain aspects, the step value (e.g., having a value greater than one) is predefined. In certain other aspects, a reader dynamically indicates the step value (e.g., having a value greater than one) to RFID tags.

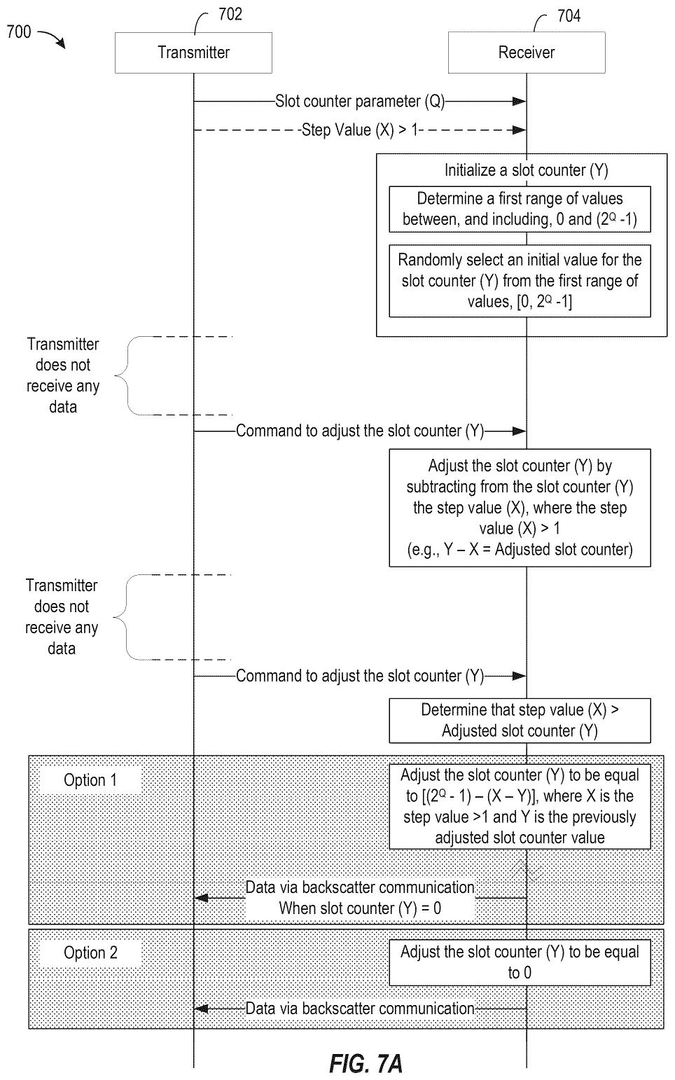

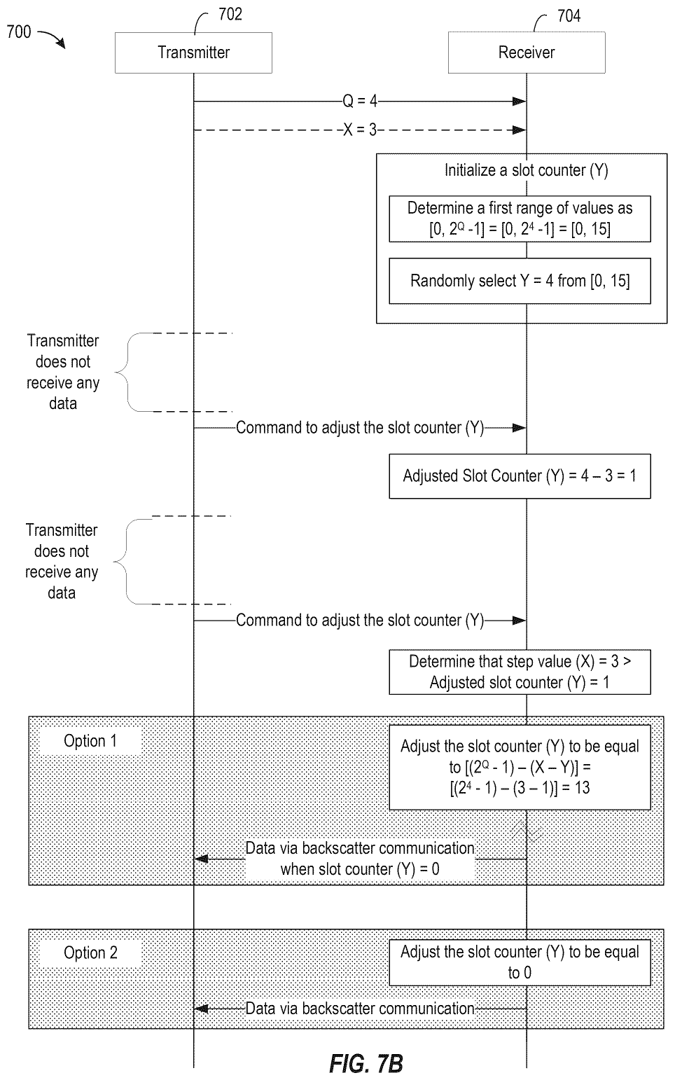

FIGS. 7A and 7B are call flow diagrams illustrating example signaling, 700, between a transmitter 702 and a receiver 704 performing an example inventory procedure using an increased adjust step. For purposes of explanation, FIG. 7B provides an illustrative example of the example inventory procedure described in FIG. 7A. More specifically, in the illustrative example of FIG. 7B, a value of the slot counter parameter is equal to four (e.g., Q=4) and a value of the step value is equal to three (e.g., X=3).

In certain aspects, transmitter 702 is a reader, such as RFID reader 510 illustrated in FIG. 5, and receiver 704 is a passive RFID tag, such as RFID tag 550 (where RFID tag 550 is a passive RFID device) illustrated in FIG. 5. However, in other aspects, transmitter 702 may be another type of wireless communications device (e.g., network entity, network node, etc.), and, similarly, receiver 704 may be another type of wireless communications device (e.g., UE, etc.), such as those described herein.

In the example inventory procedure of FIGS. 7A and 7B, the increased adjust step is a step value greater than one. In some cases, the step value is predefined. In some cases, the step value is dynamically indicated, by transmitter 702, to receiver 704.

As shown in FIGS. 7A and 7B, similar to the example inventory procedure of FIG. 6, the inventory procedure begins by transmitter 702 transmitting a value of a slot counter parameter, Q, via broadcast communication and receiver 704 initializing a slot counter value, Y. For example, as shown in FIG. 7B, transmitter 702 transmits a value of a slot counter parameter equal to four (e.g., Q=4) via broadcast communication. Receiver 704 (1) determines a first range of values between, and including zero and 2^{Q}−1, or [0, 15] (e.g., 2⁴−1=15) and (2) randomly selecting an initial value for the slot counter, Y, as Y=4 from the first range of values, [0, 15]. Receiver 704 does not backscatter a signal to transmitter 702, given the initial value for the slot counter Y, is not equal to zero.

Further, similar to the example inventory procedure of FIG. 6, in this example, other receivers which receive the broadcasted parameter, Q, may also select an initial value for the slot counter, Y, not equal to zero. Accordingly, no receiver, including receiver 704, backscatters a signal to transmitter 702. As such, transmitter 702 may not receive a response and subsequently transmits a command to adjust a value of the slot counter, Y, by a step value, X.

Unlike FIG. 6, however, in FIGS. 7A and 7B, the step value, X is greater than one such that, in response to receiving the command to adjust the value of the slot counter, Y, receiver 704 decrements a value of its slot counter, Y, by a value greater than one (e.g., Adjusted slot counter, Y_{adjusted}=Y−X, where X is >1).

In certain aspects, the step value, X, (e.g., having a value greater than one) is predefined. In certain other aspects, as shown in FIGS. 7A and 7B, transmitter 702 dynamically indicates the step value (e.g., having a value greater than one) to receiver 704.

For example, as shown in FIG. 7B, transmitter 702 provides an indication, to receiver 704, that step value, X, is equal to three (e.g., X=3). As such, when receiver 704 receives the command to adjust the slot counter, Y, receiver 704 subtracts three from slot counter, Y. In other words, receiver 704 decrements a value of the slot counter, Y=4, by three (e.g., Adjusted slot counter, Y_{adjusted}=(Y−3)=(4−3)=1). Accordingly, the adjusted slot counter value is equal to three. Again, because the adjusted slot counter value is not equal to zero, receiver 704 does not backscatter a signal to transmitter 702. It may be assumed for this example, that other receivers, also do not have an adjusted slot counter value equal to zero; thus, no signal is backscattered to transmitter 702.

Transmitter 702 may not receive a response from a receiver in a window having a (pre) defined amount of time; thus, transmitter 702 transmits another command to adjust a value of the slot counter, Y, by the step value.

In some cases, receiver 704 may determine, subsequent to receiving the command to adjust the value of the slot counter, Y, that the step value (X) is greater than a value of the slot counter, Y, or a value of the adjusted slot counter, Y_{adjusted}. Accordingly, subtracting the step value (X) from the slot counter/adjusted slot counter may result in a negative value slot counter (e.g., less than the target value of the slot counter that is equal to zero). For example, as shown in FIG. 7B, receiver 704 determines that step value (X=3)>adjusted slot counter (Y_{adjusted}=1) (e.g., 3>1). Accordingly, subtracting three from one would result in an adjusted slot counter value equal to negative two (e.g., (Y−X)=(1−3)=−2). Thus, aspects of the present disclosure introduce two options for adjusting the slot counter value when the step value is greater than then slot counter value.

In a first option, in response to (1) receiving the command to adjust a value of the slot counter, Y, and (2) determining that the step value, X, is greater than the value of the slot counter, Y (e.g., X>Y), receiver 704 adjusts the value of the slot counter, Y, to be equal to [(2^{Q}−1)−(X−Y)], where X is the step value greater than one and Y is the previously adjusted slot counter value. For example, as shown in the first option illustrated in FIG. 7B, receiver 704 adjusts the value of the slot counter (Y) to be equal to [(2⁴−1)−(3−1)]=[15−2]=13. Because the slot counter value is not equal to zero when using the first option, receiver 704 may not backscatter a signal to transmitter 702. Accordingly, the process described with respect to FIGS. 7A and 7B may repeat until a value of the slot counter is equal to zero, thereby enabling receiver 704 to backscatter a signal to transmitter 702 (or until another receiver selects a value of the slot counter equal to zero).

In a second option, in response to (1) receiving the command to adjust a value of the slot counter, Y, and (2) determining that the step value, X, is greater than the value of the slot counter, Y (e.g., X>Y), receiver 704 adjusts the value of the slot counter, Y, to be equal to zero (e.g., Y_{adjusted}=0). Because the slot counter value is equal to zero when using the second option, receiver 704 may backscatter a signal to transmitter 702.

As illustrated in FIGS. 7A and 7B, using a step value greater than one, may, in some cases, help to reduce (1) signaling overhead and (2) an amount of resources consumed until a slot counter value for receiver 704 is equal to zero. For example, where option 2 is used in FIGS. 7A and 7B, only two iterations of signaling and adjusting are needed to adjust the slot counter value such that the slot counter value is equal to zero (e.g., where the slot counter parameter was indicated to be equal to four (e.g., Q=4) and receiver 704 initializes a value of the slot counter to be equal to four (e.g., Y=4)). However, in FIG. 6, where the slot counter parameter is indicated to be equal to four (e.g., Q=4) and receiver 604 initializes a value of the slot counter to be equal to four (e.g., Y=4), three iterations of signaling and adjusting are needed to adjust the slot counter value such that the slot counter value is equal to zero.

According to aspects described herein, a second approach to reducing an amount of resources consumed and/or signaling overhead during the inventory procedure involves decreasing the slot counter value range used by an RFID tag (e.g., receiver) to initialize a value of the slot counter. For example, instead of initializing a slot counter based only on a value of a slot counter parameter, Q, (e.g., broadcasted by a reader, or transmitter), an RFID tag may initialize the slot counter based on a value of the slot counter parameter, Q, and a scaling factor. For example, instead of randomly selecting an initial value for the slot counter from a first range of values between, and including, zero and a first limit value calculated based on only the value for the slot-counter parameter, Q, (e.g., selecting a random value from [0, 2^{Q}−1]), an RFID tag may randomly select an initial value for the slot counter from a first range of values between, and including, zero and a first limit value calculated based on the value for the slot-counter parameter, Q, and a scaling factor, w, (e.g., selecting a random value from [0, 2^{wQ}−1]).

In certain aspects, the scaling factor, w, is a value greater than, or equal to, zero and less than, or equal to, one (e.g., 0≤w≤1). In certain aspects, the scaling factor, w, is based on at least one of: (1) a priority associated with data to be transmitted to the reader, from the RFID tag, via the backscatter communication or (2) the type of data to be transmitted to the reader, from the RFID tag, via backscatter communication. In particular, different data may be associated with different scaling factors, w. For example, higher priority data may be associated with a smaller scaling factor than lower priority data, such that an RFID tag transmitting the higher priority data has a greater likelihood of its slot counter being initialized or adjusted to a value equal to zero. The smaller scaling factor may reduce a range of values from which the RFID tag selects from when first initializing the value of the slot counter. For example, randomly selecting an initial value for the slot counter from [0, 2^{wQ}−1] where w=¼ and Q=4 means the RFID tag randomly selects a value for the slot counter from [0, 2^{(1/4)(4)}−1]=[0, 1], while randomly selecting an initial value for the slot counter from [0, 2^{wQ}−1] where w=½ and Q=4 means the RFID tag randomly selects a value for the slot counter from [0, 2^{(1/2)(4)}−1]=[0, 3]. An RFID tag may have a higher likelihood of randomly selecting a value of the slot counter equal to zero from two numbers, 0 and 1, than from four numbers, 0, 1, 2, and 3.

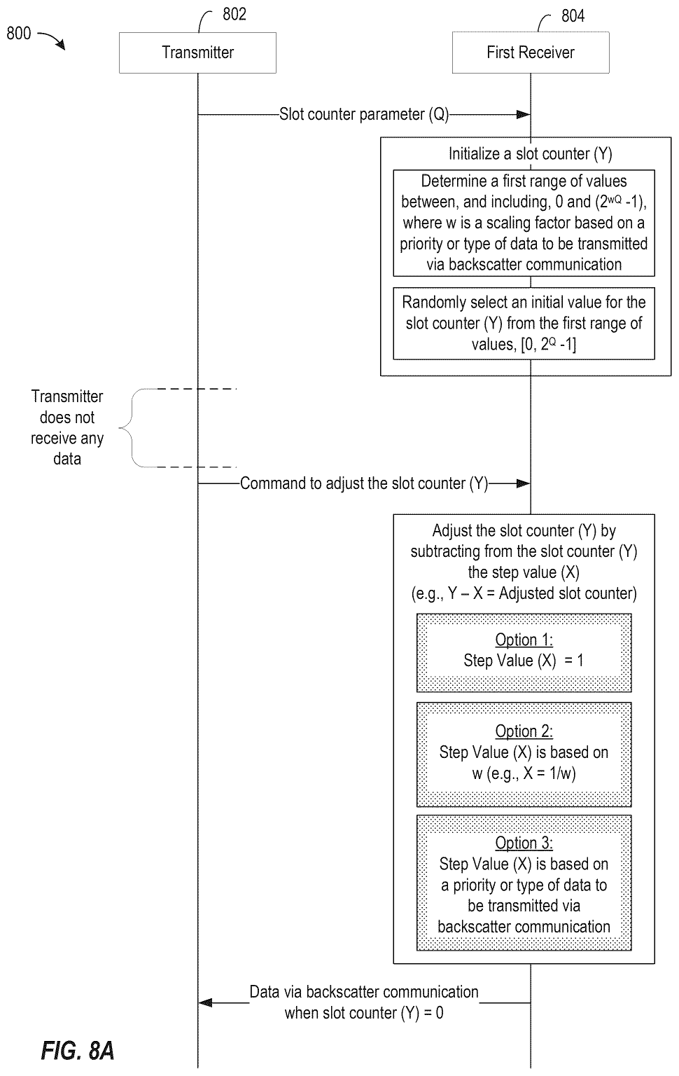

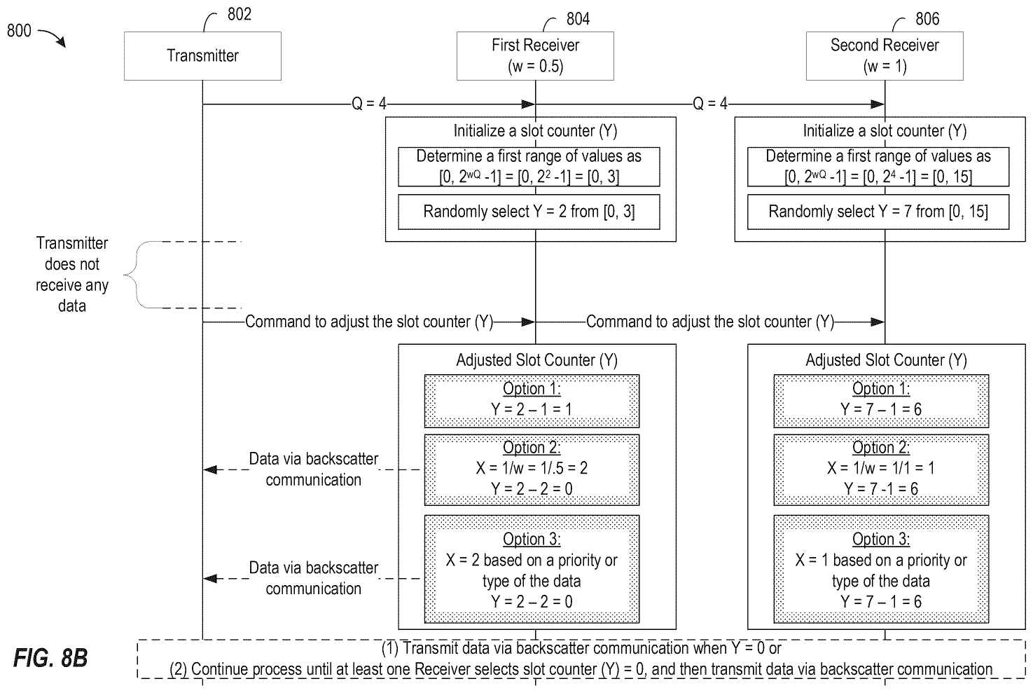

FIGS. 8A and 8B are call flow diagrams illustrating example signaling, 800, between a transmitter 802 and one or more receivers (e.g., first receiver 804 and/or second receiver 806) performing an example inventory procedure where a range of slot counter values selected by one or more of the receivers are decreased. For purposes of explanation, FIG. 8B provides an illustrative example of the example inventory procedure described in FIG. 8A.

In certain aspects, transmitter 802 is a reader, such as RFID reader 510 illustrated in FIG. 5, first receiver 804 is a passive RFID tag, such as RFID tag 550 (where RFID tag 550 is a passive RFID device) illustrated in FIG. 5, and second receiver 806 is a passive RFID tag, such as RFID tag 550 (where RFID tag 550 is a passive RFID device) illustrated in FIG. 5. However, in other aspects, transmitter 802 may be another type of wireless communications device (e.g., network entity, network node, etc.), and, similarly, first receiver 804 and second receiver 806 may be another type of wireless communications device (e.g., UE, etc.), such as those described herein.

As shown in FIGS. 8A and 8B, similar to the example inventory procedure of FIG. 6, the inventory procedure begins by transmitter 802 transmitting a value of a slot counter parameter, Q, via broadcast communication and receiver 704 initializing a slot counter value, Y. For example, as shown in FIG. 8B, transmitter 802 transmits a value of a slot counter parameter equal to four (e.g., Q=4) via broadcast communication. First receiver 804 and second receiver 806 each initialize a slot counter value, Y.

However, unlike FIG. 6 where receiver 604 randomly selects an initial value for the slot counter, Y, from the first range of values, [0, 2^{Q}−1] to initialize the slot counter, in FIGS. 8A and 8B, first receiver 804 and second receiver 806 randomly select an initial value for the slot counter, Y, from a range of values, [0, 2^{wQ}−1] to initialize the slot counter, where w is the scaling factor associated with each receiver.

For example, as shown in FIG. 8B, w=0.5 for first receiver 804 and w=1 for second receiver 806. In certain aspects, scaling factor, w, is less for first receiver 804 than second receiver 806 because data to be transmitted (e.g., via backscatter communication) by first receiver 804 has a higher priority than a priority associated with data to be transmitted (e.g., via backscatter communication) by second receiver 806. In certain aspects, scaling factor, w, is less for first receiver 804 than second receiver 806 due to different data being transmitted by first receiver 804 and second receiver 806 (e.g., different types of data have different weight factors).

First receiver 804 (1) determines a first range of values between, and including zero and 2^{wQ}−1, or [0, 3] (e.g., 2^{(0.5)(4)}−1=3) and (2) randomly selects an initial value for the slot counter, Y, as Y=2 from the first range of values, [0, 3]. Similarly, second receiver 806 (1) determines a first range of values between, and including zero and 2^{wQ}−1, or [0, 15] (e.g., 2⁽¹⁾⁽⁴⁾−1=15) and (2) randomly selects an initial value for the slot counter, Y, as Y=7 from the first range of values, [0, 15]. Both first receiver 804 and second receiver 806 do not backscatter a signal to transmitter 802, given the initial value for first receiver 804's slot counter, Y, and the initial value for second receiver 806's slot counter, Y is not equal to zero.

Further, in this example, other receivers that receive the broadcasted parameter, Q, may also select an initial value for the slot counter, Y, not equal to zero. Accordingly, no receiver, including first receiver 804 and second receiver 806, backscatters a signal to transmitter 802. As such, transmitter 802 does not receive a response and subsequently transmits a command to adjust a value of the slot counter, Y, by a step value, X.

In certain aspects, as a first option to adjust the slot counter value, Y, first receiver 804 and second receiver 806 decrement their slot counters, Y, by one (e.g., Adjusted slot counter, Y_{adjusted}=Y−X, where X is >1). For example, as shown in FIG. 8B, first receiver 804 decrements a value of its slot counter, Y=2, by one (e.g., Adjusted slot counter, Y_{adjusted}=(Y−1)=(2−1)=1). Similarly, second receiver 806 decrements a value of its slot counter, Y=7, by one (e.g., Adjusted slot counter, Y_{adjusted}=(Y−1)=(7−1)=6).

In certain aspects, as a second option to adjust the slot counter value, Y, first receiver 804 and second receiver 806 decrement their slot counters, Y, by a step value, X, that is based on each of their respective scaling factors. In certain aspects, the step value (X) may be equal to (1/w) (e.g., Adjusted slot counter, Y_{adjusted}=Y−X, where X=1/w). For example, as shown in FIG. 8B, first receiver 804 decrements a value of its slot counter, Y=2, by 1/w=1/0.5=2 (e.g., Adjusted slot counter, Y_{adjusted}=(Y−2)=(2−2)=0). Similarly, second receiver 806 decrements a value of its slot counter, Y=7, by 1/w=1/1=1 (e.g., Adjusted slot counter, Y_{adjusted}=(Y−1)=(7−1)=6).

In certain aspects, as a third option to adjust the slot counter value, Y, first receiver 804 and second receiver 806 decrement their slot counters, Y, by a step value, X, that is based on a priority associated with the data to be transmitted (e.g., via backscatter communication) by each of first receiver 804 and second receiver 806 and/or a type of the data to be transmitted (e.g., via backscatter communication) by each of first receiver 804 and second receiver 806. For example, different data types and/or priorities may map to different step values, X. For example, as shown in FIG. 8B, a priority and/or type of data to be transmitted by first receiver 804 maps to a step value, X, equal to two. As such, first receiver 804 decrements a value of its slot counter, Y=2 by X=2, such that Y_{adjusted}=(Y−2)=(2−2)=0. Similarly, a priority and/or type of data to be transmitted by second receiver 806 maps to a step value, X, equal to one. As such, second receiver 806 decrements a value of its slot counter, Y=7 by X=1, such that Y_{adjusted}=(Y−1)=(7−1)=6.

For either of the three options described, where first receiver 804 and/or second receiver 806 has a slot counter value equal to zero, first receiver 804 and/or second receiver 806 transmits a signal to transmitter 802 via backscatter communication. On the other hand, for either of the three options described, where first receiver 804 and/or second receiver 806 do not have a slot counter value equal to zero, first receiver 804 and second receiver 806 may continue to adjust their slot counter values (e.g., in response to receiving command(s) from transmitter 802) until a slot counter for first receiver 804 and/or second receiver 806 is equal to zero (e.g., to backscatter a signal to transmitter 802).

According to aspects described herein, a third approach to reducing an amount of resources consumed and/or signaling overhead during the inventory procedure involves decreasing the slot counter value range used by an RFID tag (e.g., receiver) to initialize a value of the slot counter based on a priority and/or type of data to be transmitted (e.g., via backscatter communication) by the RFID tag. For example, instead of randomly selecting an initial value for the slot counter from a first range of values between, and including, zero and a first limit value calculated based on only the value for the slot-counter parameter, Q, (e.g., selecting a random value from [0, 2^{Q}−1]), the first range of values may be divided into two sets of values, and the RFID tag may randomly select an initial value for the slot counter from one of the two sets based on a priority and/or type of data to be transmitted by the RFID tag.

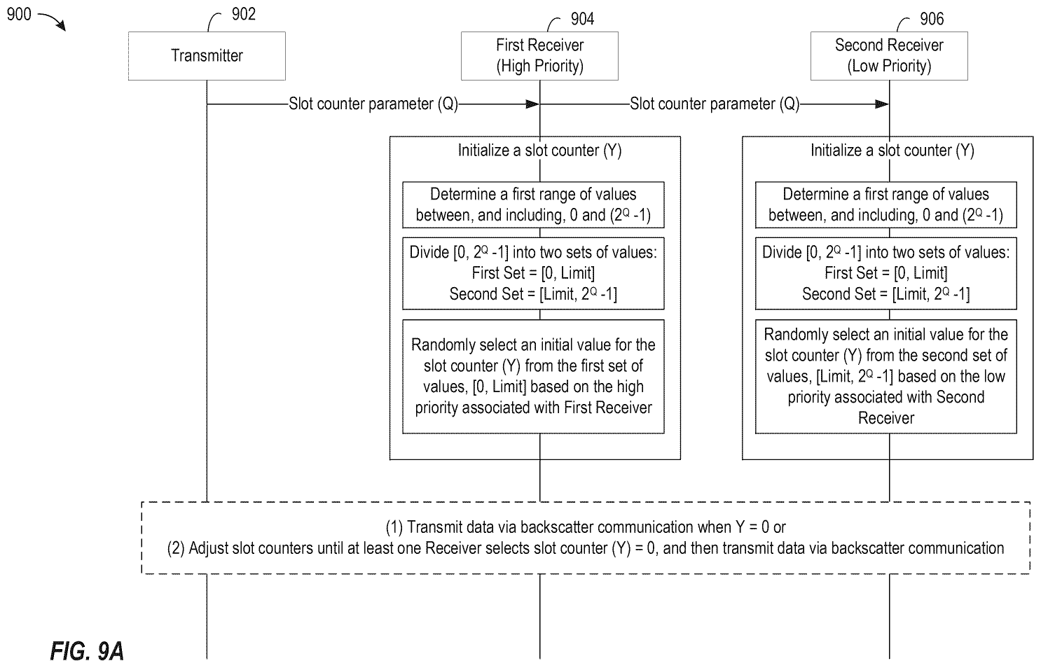

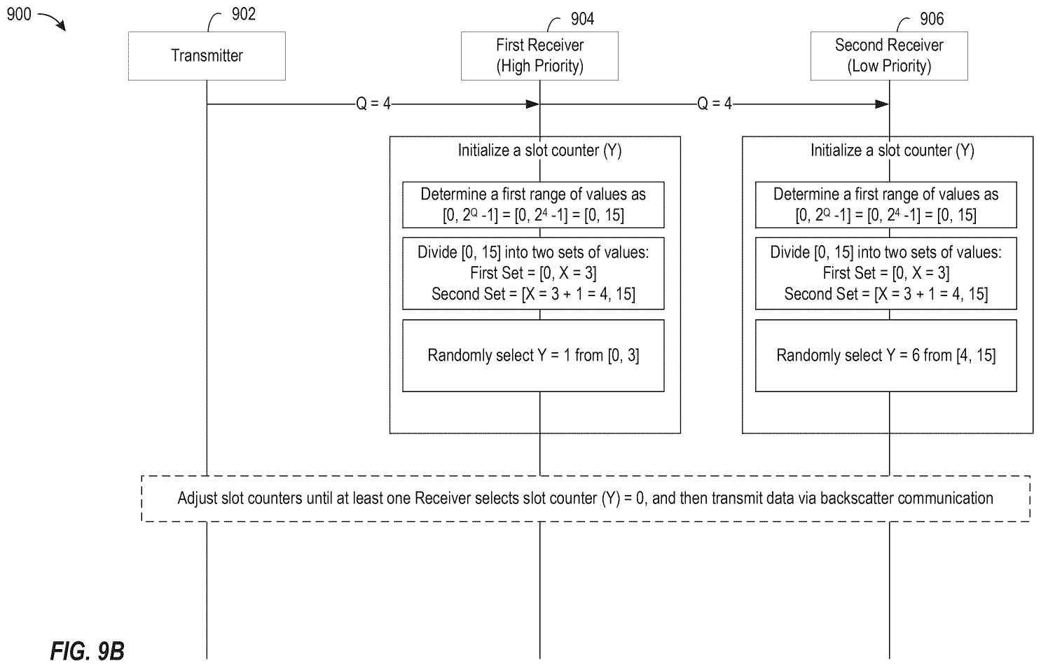

FIGS. 9A and 9B are call flow diagrams illustrating example signaling, 900, between a transmitter 902 and receivers (e.g., first receiver 904 and/or second receiver 906) performing an example inventory procedure where a range of slot counter values selected by the receivers are different. For purposes of explanation, FIG. 9B provides an illustrative example of the example inventory procedure described in FIG. 9A.

In certain aspects, transmitter 902 is a reader, such as RFID reader 510 illustrated in FIG. 5, first receiver 904 is a passive RFID tag, such as RFID tag 550 (where RFID tag 550 is a passive RFID device) illustrated in FIG. 5, and second receiver 906 is a passive RFID tag, such as RFID tag 550 (where RFID tag 550 is a passive RFID device) illustrated in FIG. 5. However, in other aspects, transmitter 902 may be another type of wireless communications device (e.g., network entity, network node, etc.), and, similarly, first receiver 904 and second receiver 906 may be another type of wireless communications device (e.g., UE, etc.), such as those described herein.

As shown in FIGS. 9A and 9B, similar to the example inventory procedure of FIG. 6, the inventory procedure begins by transmitter 902 transmitting a value of a slot counter parameter, Q, via broadcast communication and receivers 904 and 906 each initializing a slot counter value, Y. For example, as shown in FIG. 9B, transmitter 902 transmits a value of a slot counter parameter equal to four (e.g., Q=4) via broadcast communication. First receiver 904 and second receiver 906 each initialize a slot counter value, Y.

However, unlike FIG. 6 where receiver 604 randomly selects an initial value for the slot counter, Y, from the first range of values, [0, 2^{Q}−1] to initialize the slot counter, in FIGS. 9A and 9B, first receiver 904 and second receiver 906 randomly select an initial value for the slot counter, Y, from different sets of values. In particular, a range of values, [0, 2^{Q}−1] may be broken into a first set of values, [0, Limit], and a second set of values, [(Limit+1), 2^{Q}−1]. In some cases, the limit is predefined. In some cases, the limit is equal to a step value, X, such that the first set of values includes [0, X], and the second set of values includes [X+1, 2^{Q}−1]. In certain aspects, which set of values each receiver selects a random value from depends on a priority and/or type of data to be transmitted (e.g., via backscatter communication) by each receiver. This may help to prevent collision of higher priority data to be transmitted by a first receiver and lower priority data to be transmitted by a second receiver (e.g., where both receivers select a value of their slot counter equal to zero and backscatter the data).

For example, as shown in FIG. 9B, data to be transmitted (e.g., via backscatter communication) by first receiver 904 has a higher priority than a priority associated with data to be transmitted (e.g., via backscatter communication) by second receiver 906. As such, first receiver 904 randomly selects an initial value for its slot counter, Y, from a first set of values [0, X=3] (e.g., including 0 and 3), and second receiver 906 randomly selects an initial value for its slot counter, Y, from a second set of values [X=3+1, 2^{Q}−1] or [4, 15] (e.g., including 4 and 15), where Q=4. In the example illustrated, first receiver 904 randomly selects an initial value for its slot counter, Y, as Y=1 from the first set of values, [0, 3], and second receiver 906 randomly selects an initial value for its slot counter, Y, as Y=6 from the second set of values, [4, 15]. Both first receiver 904 and second receiver 906 do not backscatter a signal to transmitter 902, given the initial value for first receiver 904's slot counter, Y, and the initial value for second receiver 906's slot counter, Y, is not equal to zero.

Where first receiver 904 and/or second receiver 906 do not have a slot counter value equal to zero, first receiver 904 and second receiver 906 may continue to adjust their slot counter values (e.g., in response to receiving command(s) from transmitter 902) until a slot counter for first receiver 904 and/or second receiver 906 is equal to zero (e.g., to backscatter a signal to transmitter 802). Adjustment of their slot counters may be based on previously described methods for adjusting the slot counter described in FIGS. 7A-8B.

In certain aspects, more than one RFID tag may have a slot counter value equal to zero (e.g., after initialization of the slot counter value or after adjusting the slot counter value); thus, more than one RFID tag may transmit data to the reader via backscatter communication. Backscattered data from more than one RFID tag may result in a collision, which the reader may not be able to resolve (may not be able to distinguish which data is from which RFID tag). Accordingly, the reader may issue a QueryAdjust or QueryRep command (or a negative ACK (NACK)).

In some cases, with the issued command, the reader may indicate to decrement slot counter values by one. In response to receiving this command, slot counters for RFID tags which backscattered data that collided (e.g., referred to as “collided RFID tags”) may be equal to (2^{wQ}−1), where w is the scaling factor and Q is the slot counter parameter. As mentioned, in certain aspects, the scaling factor, w, is based on a priority associated with data to be transmitted to the reader, from the RFID tag, via the backscatter communication (or a priority of the RFID tag). Accordingly, slot counter values for RFID tags transmitting data with a same priority (or RFID tags having a same priority) may be the same, while slot counter values for RFID tags transmitting data with different priorities (or RFID tags having different priorities) may be different.

In some other cases, with the issued command, the reader may indicate a new slot counter parameter, Q_{New}, for the collided RFID tags. The collided RFID tags will randomly select a value for their slot counter using one of the approaches described above (e.g., for example, randomly select a value for their slot counter from a range of values between, and including, zero and a limit value calculated based on the new value for the slot-counter parameter, Q_{New}). Other RFID tags which received the original slot counter parameter and initialized their slot counter (e.g., based on the original slot counter parameter) may continue to use (e.g., keep) their current slot counter value.

According to aspects described herein, a fourth approach to reducing an amount of resources consumed and/or signaling overhead during an inventory procedure involves initializing a slot counter by randomly selecting a value for the slot counter using a weighted distribution. In other words, a probability of a first RFID tag (e.g., a first receiver) selecting a slot counter value equal to zero may be greater than a probability of a second RFID tag (e.g., a second receiver) selecting a slot counter value equal to zero. In certain aspects, an RFID tag having a higher priority (or which is to transmit higher priority data) may have a higher probability of selecting a value of the slot counter equal to zero than an RFID tag having a lower priority (or which is to transmit lower priority data).

In particular, the probability of an RFID tag choosing slot counter value (q)=i is

$$P r ( q = i ) = \frac{{w}_{i}}{T} ,$$

where T=Eᵢwᵢ. In certain aspects, wᵢ includes positive integers. For example, where only RFID tags having a slot counter value (q)=0 are to transmit a signal via backscatter communication, w₀ would be equal to 1, 2, 3, . . . for different priorities (e.g., w₀=1, 2, 3, . . . ) while other weights, wᵢ=1, for i≥1.

According to aspects described herein, a fifth approach to reducing an amount of resources consumed and/or signaling overhead during an inventory procedure involves a reader explicitly indicating which RFID tag(s) are to transmit a signal via backscatter communication.

Though the example inventory procedures illustrated in FIGS. 7A-9B illustrate only the use of “QueryRep” commands (e.g., commands prompting each of the passive RFID tags to decrement their slot counter value), in certain embodiments, “Query Adjust” commands (e.g., commands prompting each of the passive RFID tags to adjust the value of Q and select a new random number in the range of [0, 2^{Q}−1] (e.g., where Q is the newly adjusted Q) as their corresponding slot counter value) may be used as an alternative to the illustrated “QueryRep” commands or in addition to the illustrated “QueryRep” commands.

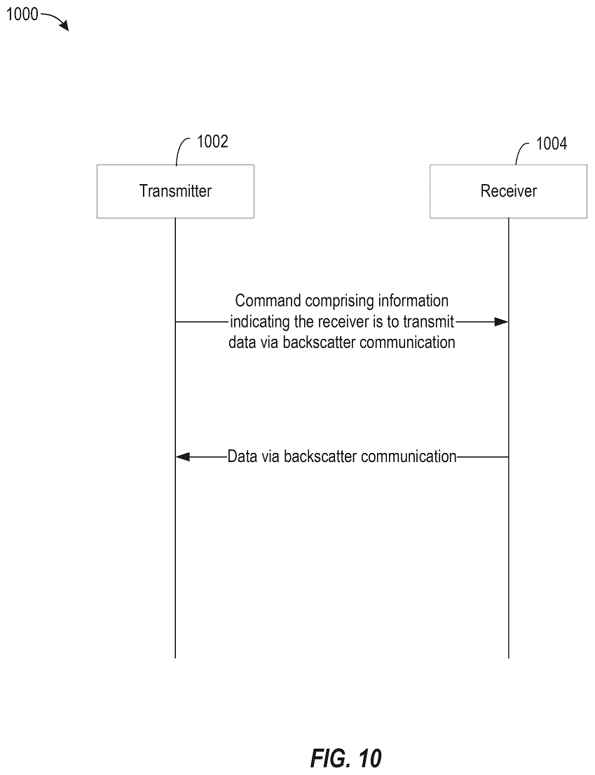

FIG. 10 is a call flow diagram illustrating example signaling between a transmitter 1002 and a receiver 1004 performing an example inventory procedure using an explicit indication of receiver 1004. In certain aspects, transmitter 1002 is a reader, such as RFID reader 510 illustrated in FIG. 5, and receiver 1004 is a passive RFID tag, such as RFID tag 550 (where RFID tag 550 is a passive RFID device) illustrated in FIG. 5. However, in other aspects, transmitter 1002 may be another type of wireless communications device (e.g., network entity, network node, etc.), and, similarly, receiver 1004 may be another type of wireless communications device (e.g., UE, etc.), such as those described herein.

As shown in FIG. 10, the inventory procedure begins by transmitter 1002 transmitting a command comprising information identifying at least one device to transmit data via backscatter communication to the transmitter. In the example illustrated in FIG. 10, the information, at least, identifies receiver 1004 is to transmit data via backscatter communication to the transmitter. Accordingly, in response to receiving this information, receiver 1004 transmits the data to transmitter 1002, via backscatter communication.

In certain aspects, the information identifying the at least one device comprises a portion of an ID associated with the at least one device. For example, the information may include a portion of an ID associated with receiver 1004 to indicate that receiver 1004 is to transmit the data via backscatter communication. In certain aspects, the portion of the ID of receiver 1004 may include the first M most significant bits (MSBs) of receiver 1004's ID, where M is an integer greater than zero. For example, in certain aspects, the portion of the ID of receiver 1004 may include the first six MSBs of receiver 1004's ID, where M is equal to six (e.g., M=6). In certain aspects, M may be dynamically indicated by the network.

In certain aspects, the information identifying the at least one device comprises a first value (Y) equal to a modulo function of at least a portion of an ID associated with the at least one device and a second value (X). For example, the information indicate that receiver 1004 is to transmit the data via backscatter communication when the first value (Y) equals a modulo function of at least a portion of the ID associated with receiver 1004 and a second value (X) (e.g., when Y=mod (All/Portion of Tag ID of Receiver 1004, X)). In certain aspects, the information identifying the at least one device further comprises the second value (X). In certain aspects, the second value (X) is predefined.

In certain aspects, the information identifying the at least one device comprises an indication of a type of the at least one device. For example, the information may include a device type of receiver 1004 to indicate that receiver 1004 is to transmit the data via backscatter communication. In certain aspects, the indication of the type comprises a selected flag (SL flag) associated with at least one device.

In certain aspects, different devices, including receiver 1004, may be grouped into different device types. As such, indication of a type of the at least one device may indicate that receiver 1004 one other device is to transmit data via backscatter communication where receiver 1004 and the other device belong to the same group (e.g., are of the same type).

In certain aspects, the information identifies the receiver and at least one other device is to transmit the data via the backscatter communication to the transmitter (e.g., more than one device may be indicated to backscatter data). Accordingly, in certain aspects, the command further comprises a value of a slot counter parameter, Q, to prevent contention between indicated devices. As such, to transmit data via backscatter communication to transmitter 1002, receiver 1004, may need to be identified by the information in the command and select a value of a slot counter equal to zero (e.g., based on the indicated slot counter parameter, Q).

In certain aspects, the value of the slot counter parameter, Q, included in the command is based on a number of devices identified in the information. For example, the information included in the command may include 4 MSBs of different tag IDs. These 4 MSBs may be MSBs of five different devices. To prevent contention between each of these five devices, the command may further indicate a slot counter parameter, Q, which is equal to four (e.g., Q=4). The five devices may initialize their corresponding slot counter using Q=4. One or more of the five devices which initializes their slot counter to be equal to zero may backscatter the data. In another example, however, the information included in the command may include 6 MSBs of different tag IDs. These 6 MSBs may be MSBs of two different devices, instead of five different devices. To prevent contention between each of these two devices, the command may further indicate a slot counter parameter, Q, which is equal to two (e.g., Q=2). In this case, because the information indicates less devices (e.g., two devices<five devices), the slot counter parameter, Q, may be smaller (e.g., (Q=2)<(Q=4)).

In certain aspects, more than one RFID tag may have a slot counter value equal to zero (e.g., after initialization of the slot counter value or after adjusting the slot counter value); thus, more than one RFID tag may transmit data to the reader via backscatter communication. Backscattered data from more than one RFID tag may result in a collision, which the reader may not be able to resolve (may not be able to distinguish which data is from which RFID tag). Accordingly, the reader may issue a QueryAdjust or QueryRep command. The reader may indicate a new slot counter parameter, Q_{New}, for the RFID tags which backscattered data that collided (e.g., referred to as “collided RFID tags”). The collided RFID tags will randomly select a value for their slot counter using one of the approaches described above (e.g., for example, randomly select a value for their slot counter from a range of values between, and including, zero and a limit value calculated based on the new value for the slot-counter parameter, Q_{New}). Other RFID tags which received the original slot counter parameter and initialized their slot counter (e.g., based on the original slot counter parameter) may continue to use (e.g., keep) their current slot counter value.

Example approaches for group-based access of passive RFID tags are described in more detail in commonly owned International Patent Application No. PCT/CN2022/106658, (Attorney Docket No. 2202192WO1), entitled “GROUP-BASED ACCESS OF PASSIVE RFID TAGS,” filed on the same day, the entire content of which is incorporated herein by reference.

### Example Operations of a Receiver

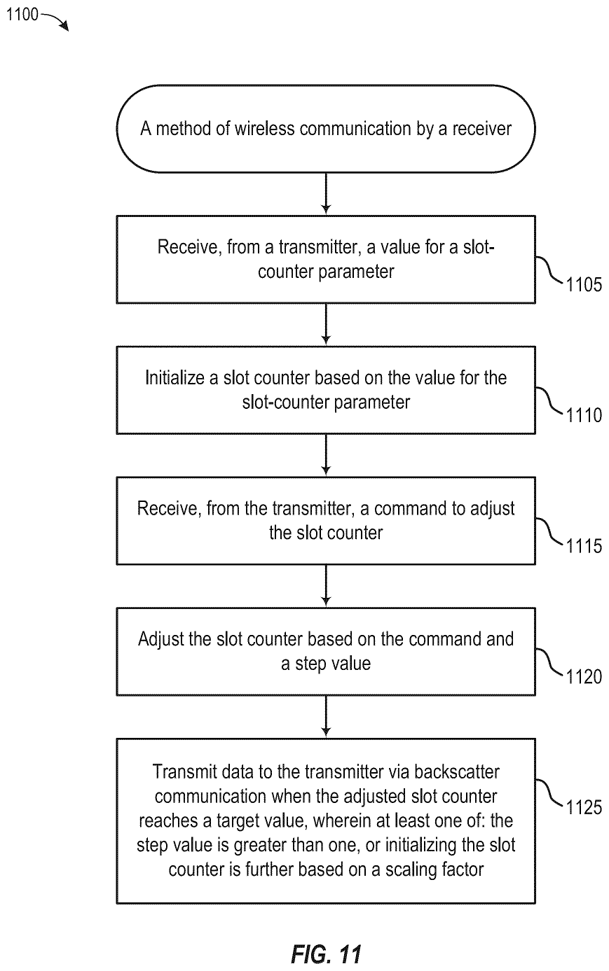

FIG. 11 shows an example of a method 1100 of wireless communication by a receiver. In some aspects, the receiver may be a UE, such as a UE 104 of FIGS. 1 and 3.

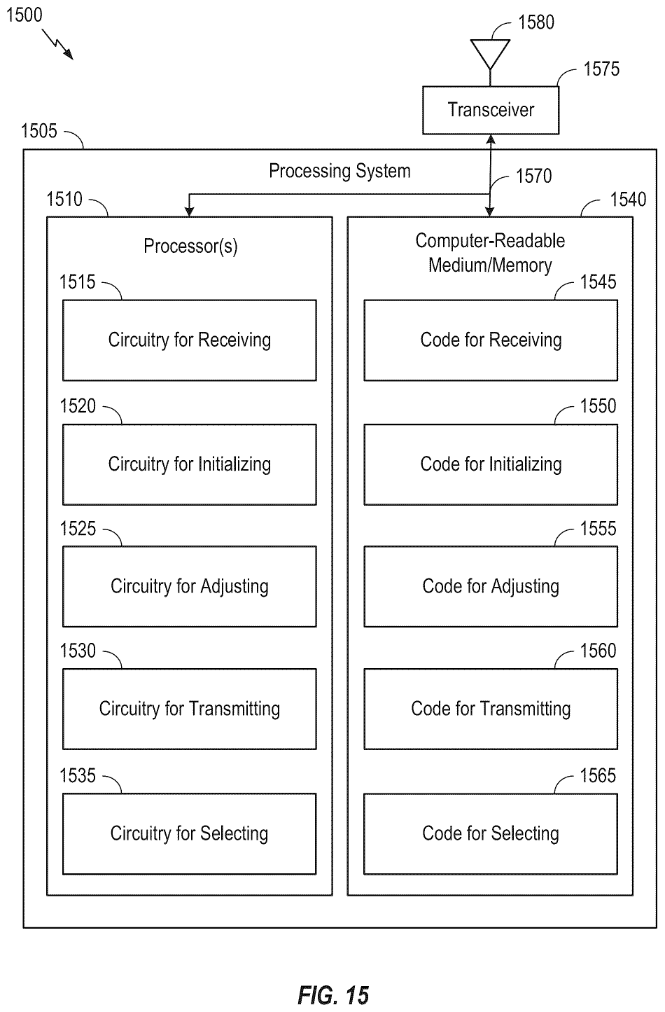

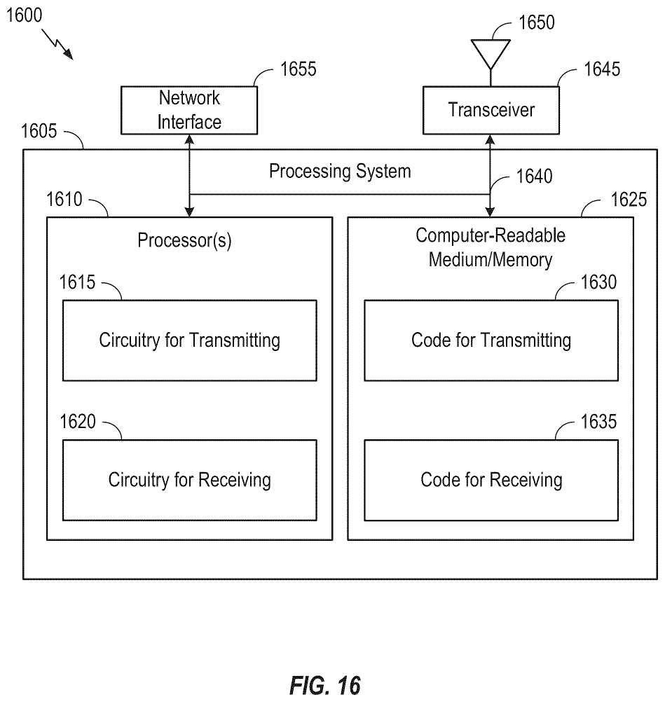

Method 1100 begins at step 1105 with receiving, from a transmitter, a value for a slot-counter parameter. In some cases, the operations of this step refer to, or may be performed by, circuitry for receiving and/or code for receiving as described with reference to FIG. 15.

Method 1100 then proceeds to step 1110 with initializing a slot counter based on the value for the slot-counter parameter. In some cases, the operations of this step refer to, or may be performed by, circuitry for initializing and/or code for initializing as described with reference to FIG. 15.

Method 1100 then proceeds to step 1115 with receiving, from the transmitter, a command to adjust the slot counter. In some cases, the operations of this step refer to, or may be performed by, circuitry for receiving and/or code for receiving as described with reference to FIG. 15.

Method 1100 then proceeds to step 1120 with adjusting the slot counter based on the command and a step value. In some cases, the operations of this step refer to, or may be performed by, circuitry for adjusting and/or code for adjusting as described with reference to FIG. 15.

Method 1100 then proceeds to step 1125 with transmitting data to the transmitter via backscatter communication when the adjusted slot counter reaches a target value, wherein at least one of: the step value is greater than one, or initializing the slot counter is further based on a scaling factor. In some cases, the operations of this step refer to, or may be performed by, circuitry for transmitting and/or code for transmitting as described with reference to FIG. 15.

In some aspects, the receiver comprises a UE the transmitter comprises a network entity.

In some aspects, initializing the slot counter comprises: randomly selecting an initial value for the slot counter from a first range of values between, and including, zero and a first limit value calculated based on the value for the slot-counter parameter.

In some aspects, adjusting the slot counter based on the command and the step value comprises: determining the initial value for the slot counter is less than the step value; and based on determining the initial value for the slot counter is less than the step value, using as the adjusted slot counter a value equal to the first limit value minus a difference between the step value and the initial value for the slot counter.

In some aspects, adjusting the slot counter based on the command and the step value comprises: determining the slot counter is initialized to a value less than the step value; and selecting a value for the adjusted slot counter equal to zero based on determining the slot counter is initialized to the value less than the step value.

In some aspects, adjusting the slot counter based on the command and the step value comprises: determining the slot counter is initialized to a value greater than the step value; and based on determining the slot counter is initialized to the value greater than the step value, subtracting the step value from the value for the slot counter.

In some aspects, the step value is predefined.

In some aspects, the method 1100 further includes receiving, from the transmitter, the step value. In some cases, the operations of this step refer to, or may be performed by, circuitry for receiving and/or code for receiving as described with reference to FIG. 17.

In some aspects, the scaling factor is based on at least one of: a priority associated with the data to be transmitted to the transmitter via the backscatter communication; or a type of the data to be transmitted to the transmitter via the backscatter communication.

In some aspects, initializing the slot counter comprises: randomly selecting an initial value for the slot counter from a first range of values between, and including, zero and a first limit value calculated based on the value for the slot-counter parameter and the scaling factor.

In some aspects, the step value is based on the scaling factor.

In some aspects, initializing the slot counter comprises: determining a first range of values between, and including, zero and a first limit value, the first limit value calculated based on the value for the slot-counter parameter; dividing the first range of values into a first set of values and a second set of values; and randomly selecting a value for the slot counter from the first set of values or the second set of values based on a type of the data.

In some aspects, the step value is based on the type of the data.

In some aspects, initializing the slot counter comprises: randomly selecting an initial value for the slot counter from a first range of values between, and including, zero and a first limit value calculated based on the value for the slot-counter parameter, wherein a probability of the receiver selecting the initial value for the slot counter equal to the target value is based on a priority associated with the data.

In one aspect, method 1100, or any aspect related to it, may be performed by an apparatus, such as communications device 1500 of FIG. 15, which includes various components operable, configured, or adapted to perform the method 1100. Communications device 1500 is described below in further detail.

Note that FIG. 11 is just one example of a method, and other methods including fewer, additional, or alternative steps are possible consistent with this disclosure.

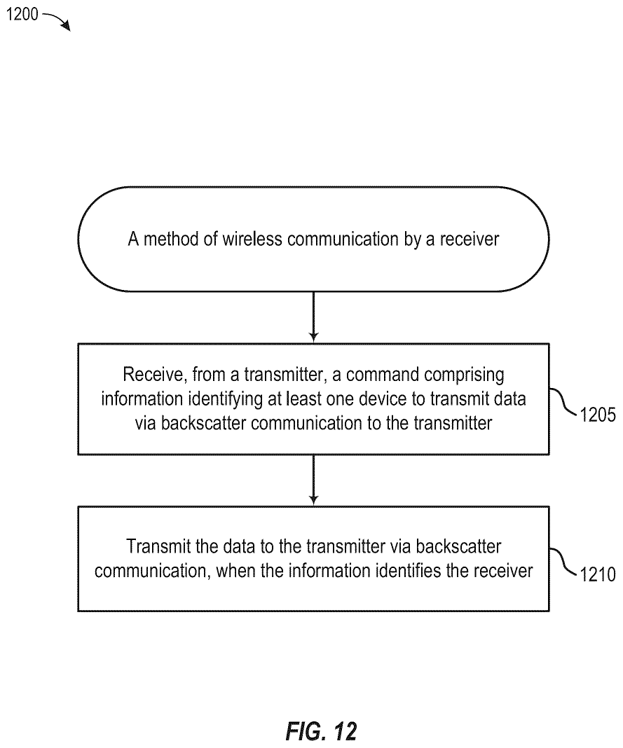

FIG. 12 shows an example of a method 1200 of wireless communication by a receiver. In some aspects, the receiver may be a UE, such as a UE 104 of FIGS. 1 and 3.

Method 1200 begins at step 1205 with receiving, from a transmitter, a command comprising information identifying at least one device to transmit data via backscatter communication to the transmitter. In some cases, the operations of this step refer to, or may be performed by, circuitry for receiving and/or code for receiving as described with reference to FIG. 15.

Method 1200 then proceeds to step 1210 with transmitting the data to the transmitter via backscatter communication, when the information identifies the receiver. In some cases, the operations of this step refer to, or may be performed by, circuitry for transmitting and/or code for transmitting as described with reference to FIG. 15.

In some aspects, the receiver comprises a UE and the transmitter comprises a network entity.

In some aspects, the information identifying the at least one device comprises a portion of an ID associated with the at least one device.

In some aspects, the information identifying the at least one device comprises a first value equal to a modulo function of at least a portion of an ID associated with the at least one device and a second value.

In some aspects, the information identifying the at least one device further comprises the second value.

In some aspects, the second value is predefined.

In some aspects, the information identifying the at least one device comprises an indication of a type of the at least one device.

In some aspects, the indication of the type comprises an SL flag associated with at least one device.

In some aspects, the information identifies the receiver and at least one other device is to transmit the data via the backscatter communication to the transmitter; and the command further comprises a value of a slot-counter parameter.

In some aspects, the method 1200 further includes selecting a value for a slot counter based on the value of the slot-counter parameter, wherein the transmitting the data to the transmitter is further based on the receiver selecting the value for the slot counter equal to a target value. In some cases, the operations of this step refer to, or may be performed by, circuitry for selecting and/or code for selecting as described with reference to FIG. 15.

In some aspects, the value of the slot-counter parameter is based on a number of devices identified in the information.

In one aspect, method 1200, or any aspect related to it, may be performed by an apparatus, such as communications device 1500 of FIG. 15, which includes various components operable, configured, or adapted to perform the method 1200. Communications device 1500 is described below in further detail.

Note that FIG. 12 is just one example of a method, and other methods including fewer, additional, or alternative steps are possible consistent with this disclosure.

### Example Operations of a Transmitter

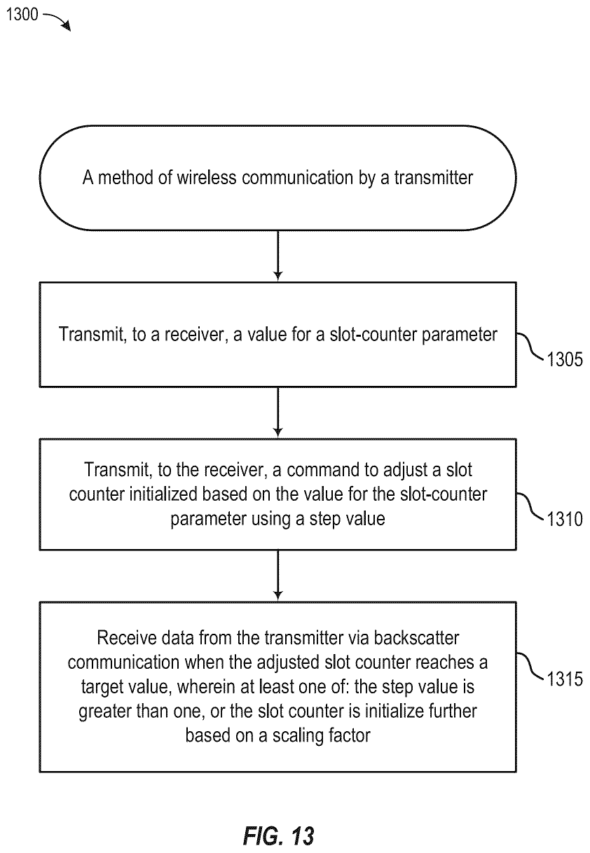

FIG. 13 shows an example of a method 1300 of wireless communication by a transmitter. In some aspects, the transmitter is a network entity, such as a BS 102 of FIGS. 1 and 3, or a disaggregated base station as discussed with respect to FIG. 2.

Method 1300 begins at step 1305 with transmitting, to a receiver, a value for a slot-counter parameter. In some cases, the operations of this step refer to, or may be performed by, circuitry for transmitting and/or code for transmitting as described with reference to FIG. 16.

Method 1300 then proceeds to step 1310 with transmitting, to the receiver, a command to adjust a slot counter initialized based on the value for the slot-counter parameter using a step value. In some cases, the operations of this step refer to, or may be performed by, circuitry for transmitting and/or code for transmitting as described with reference to FIG. 16.

Method 1400 then proceeds to step 1315 with receiving data from the transmitter via backscatter communication when the adjusted slot counter reaches a target value, wherein at least one of: the step value is greater than one, or the slot counter is initialized further based on a scaling factor. In some cases, the operations of this step refer to, or may be performed by, circuitry for receiving and/or code for receiving as described with reference to FIG. 16.

In some aspects, the transmitter comprises a network entity and the receiver comprises a UE.

In some aspects, initializing the slot counter comprises: randomly selecting an initial value for the slot counter from a first range of values between, and including, zero and a first limit value calculated based on the value for the slot-counter parameter.

In some aspects, the step value is predefined.

In some aspects, the method 1300 further includes transmitting, to the receiver, the step value. In some cases, the operations of this step refer to, or may be performed by, circuitry for transmitting and/or code for transmitting as described with reference to FIG. 16.

In some aspects, the scaling factor is based on at least one of: a priority associated with the data to be received by the transmitter via the backscatter communication; or a type of the data to be received by the transmitter via the backscatter communication.

In some aspects, the step value is based on the scaling factor.

In some aspects, the step value is based on a type of the data.

In one aspect, method 1300, or any aspect related to it, may be performed by an apparatus, such as communications device 1600 of FIG. 16, which includes various components operable, configured, or adapted to perform the method 1300. Communications device 1600 is described below in further detail.

Note that FIG. 13 is just one example of a method, and other methods including fewer, additional, or alternative steps are possible consistent with this disclosure.

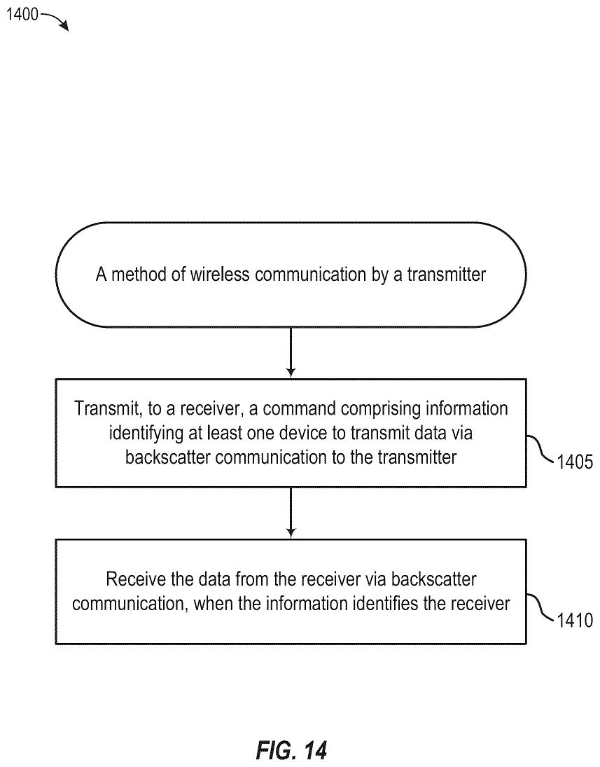

FIG. 14 shows an example of a method 1400 of wireless communication by a transmitter. In some aspects, the transmitter is a network entity, such as a BS 102 of FIGS. 1 and 3, or a disaggregated base station as discussed with respect to FIG. 2.

Method 1400 begins at step 1405 with transmitting, to a receiver, a command comprising information identifying at least one device to transmit data via backscatter communication to the transmitter. In some cases, the operations of this step refer to, or may be performed by, circuitry for transmitting and/or code for transmitting as described with reference to FIG. 16.

Method 1400 then proceeds to step 1410 with receiving the data from the receiver via backscatter communication, when the information identifies the receiver. In some cases, the operations of this step refer to, or may be performed by, circuitry for receiving and/or code for receiving as described with reference to FIG. 16.

In some aspects, the transmitter comprises a network entity and the receiver comprises a UE.

In some aspects, the information identifying the at least one device comprises a portion of an ID associated with the at least one device.

In some aspects, the information identifying the at least one device comprises a first value equal to a modulo function of at least a portion of an ID associated with the at least one device and a second value.

In some aspects, the information identifying the at least one device further comprises the second value.

In some aspects, the second value is predefined.

In some aspects, the information identifying the at least one device comprises an indication of a type of the at least one device.

In some aspects, the indication of the type comprises an SL flag associated with at least one device.

In some aspects, the information identifies the receiver and at least one other device is to transmit the data via the backscatter communication to the transmitter; and the command further comprises a value of a slot-counter parameter.

In some aspects, the receiving the data from the receiver is further based on the receiver selecting the value for a slot counter, based on the value of the slot-counter parameter, equal to a target value.

In some aspects, the value of the slot-counter parameter is based on a number of devices identified in the information.

In one aspect, method 1400, or any aspect related to it, may be performed by an apparatus, such as communications device 1600 of FIG. 16, which includes various components operable, configured, or adapted to perform the method 1400. Communications device 1600 is described below in further detail.

Note that FIG. 14 is just one example of a method, and other methods including fewer, additional, or alternative steps are possible consistent with this disclosure.

### Example Communications Devices

FIG. 15 depicts aspects of an example communications device 1500. In some aspects, communications device 1500 is a user equipment, such as UE 104 described above with respect to FIGS. 1 and 3.

The communications device 1500 includes a processing system 1505 coupled to the transceiver 1575 (e.g., a transmitter and/or a receiver). The transceiver 1575 is configured to transmit and receive signals for the communications device 1500 via the antenna 1580, such as the various signals as described herein. The processing system 1505 may be configured to perform processing functions for the communications device 1500, including processing signals received and/or to be transmitted by the communications device 1500.

The processing system 1505 includes one or more processors 1510. In various aspects, the one or more processors 1510 may be representative of one or more of receive processor 358, transmit processor 364, TX MIMO processor 366, and/or controller/processor 380, as described with respect to FIG. 3. The one or more processors 1510 are coupled to a computer-readable medium/memory 1540 via a bus 1570. In certain aspects, the computer-readable medium/memory 1540 is configured to store instructions (e.g., computer-executable code) that when executed by the one or more processors 1510, cause the one or more processors 1510 to perform: the method 1100 described with respect to FIG. 11, or any aspect related to it, and/or the method 1200 described with respect to FIG. 12, or any aspect related to it. Note that reference to a processor performing a function of communications device 1500 may include one or more processors 1510 performing that function of communications device 1500.

In the depicted example, computer-readable medium/memory 1540 stores code (e.g., executable instructions), such as code for receiving 1545, code for initializing 1750, code for adjusting 1555, code for transmitting 1560, and code for selecting 1565. Processing of the code for receiving 1545, code for initializing 1550, code for adjusting 1555, code for transmitting 1560, and code for selecting 1565 may cause the communications device 1500 to perform: the method 1100 described with respect to FIG. 11, or any aspect related to it, and/or the method 1200 described with respect to FIG. 12, or any aspect related to it.

The one or more processors 1510 include circuitry configured to implement (e.g., execute) the code stored in the computer-readable medium/memory 1540, including circuitry such as circuitry for receiving 1515, circuitry for initializing 1520, circuitry for adjusting 1525, circuitry for transmitting 1530, and circuitry for selecting 1535. Processing with circuitry for receiving 1515, circuitry for initializing 1520, circuitry for adjusting 1525, circuitry for transmitting 1530, and circuitry for selecting 1535 may cause the communications device 1500 to perform: the method 1100 described with respect to FIG. 11, or any aspect related to it, and/or the method 1200 described with respect to FIG. 12, or any aspect related to it.

Various components of the communications device 1500 may provide means for performing: the method 1100 described with respect to FIG. 11, or any aspect related to it, and/or the method 1200 described with respect to FIG. 12, or any aspect related to it. For example, means for transmitting, sending or outputting for transmission may include transceivers 354 and/or antenna(s) 352 of the UE 104 illustrated in FIG. 3 and/or the transceiver 1575 and the antenna 1580 of the communications device 1500 in FIG. 15. Means for receiving or obtaining may include transceivers 354 and/or antenna(s) 352 of the UE 104 illustrated in FIG. 3 and/or the transceiver 1575 and the antenna 1580 of the communications device 1500 in FIG. 15.

FIG. 16 depicts aspects of an example communications device 1600. In some aspects, communications device 1600 is a network entity, such as BS 102 of FIGS. 1 and 3, or a disaggregated base station as discussed with respect to FIG. 2.

The communications device 1600 includes a processing system 1605 coupled to the transceiver 1645 (e.g., a transmitter and/or a receiver) and/or a network interface 1655. The transceiver 1645 is configured to transmit and receive signals for the communications device 1600 via the antenna 1650, such as the various signals as described herein. The network interface 1655 is configured to obtain and send signals for the communications device 1600 via communication link(s), such as a backhaul link, midhaul link, and/or fronthaul link as described herein, such as with respect to FIG. 2. The processing system 1605 may be configured to perform processing functions for the communications device 1600, including processing signals received and/or to be transmitted by the communications device 1600.

The processing system 1605 includes one or more processors 1610. In various aspects, one or more processors 1610 may be representative of one or more of receive processor 338, transmit processor 320, TX MIMO processor 330, and/or controller/processor 340, as described with respect to FIG. 3. The one or more processors 1610 are coupled to a computer-readable medium/memory 1625 via a bus 1640. In certain aspects, the computer-readable medium/memory 1625 is configured to store instructions (e.g., computer-executable code) that when executed by the one or more processors 1610, cause the one or more processors 1610 to perform: the method 1300 described with respect to FIG. 13, or any aspect related to it, and/or the method 1400 described with respect to FIG. 14, or any aspect related to it. Note that reference to a processor of communications device 1600 performing a function may include one or more processors 1610 of communications device 1600 performing that function.

In the depicted example, the computer-readable medium/memory 1625 stores code (e.g., executable instructions), such as code for transmitting 1630 and code for receiving 1635. Processing of the code for transmitting 1630 and code for receiving 1635 may cause the communications device 1600 to perform: the method 1300 described with respect to FIG. 13, or any aspect related to it, and/or the method 1400 described with respect to FIG. 14, or any aspect related to it.

The one or more processors 1610 include circuitry configured to implement (e.g., execute) the code stored in the computer-readable medium/memory 1625, including circuitry such as circuitry for transmitting 1615 and circuitry for receiving 1620. Processing with circuitry for transmitting 1615 and circuitry for receiving 1620 may cause the communications device 1600 to perform: the method 1300 described with respect to FIG. 13, or any aspect related to it, and/or the method 1400 described with respect to FIG. 14, or any aspect related to it.

Various components of the communications device 1600 may provide means for performing: the method 1300 described with respect to FIG. 13, or any aspect related to it, and/or the method 1400 described with respect to FIG. 14, or any aspect related to it. Means for transmitting, sending or outputting for transmission may include transceivers 332 and/or antenna(s) 334 of the BS 102 illustrated in FIG. 3 and/or the transceiver 1645 and the antenna 1650 of the communications device 1600 in FIG. 16. Means for receiving or obtaining may include transceivers 332 and/or antenna(s) 334 of the BS 102 illustrated in FIG. 3 and/or the transceiver 1645 and the antenna 1650 of the communications device 1600 in FIG. 16.

### Example Clauses

Implementation examples are described in the following numbered clauses:

Clause 1: A method of wireless communication by a receiver, comprising: receiving, from a transmitter, a value for a slot-counter parameter; initializing a slot counter based on the value for the slot-counter parameter; receiving, from the transmitter, a command to adjust the slot counter; adjusting the slot counter based on the command and a step value; and transmitting data to the transmitter via backscatter communication when the adjusted slot counter reaches a target value, wherein at least one of: the step value is greater than one, or initializing the slot counter is further based on a scaling factor.

Clause 2: The method of Clause 1, wherein the step value is greater than one.

Clause 3: The method of Clause 2, wherein initializing the slot counter comprises: randomly selecting an initial value for the slot counter from a first range of values between, and including, zero and a first limit value calculated based on the value for the slot-counter parameter.

Clause 4: The method of Clause 3, wherein adjusting the slot counter based on the command and the step value comprises: determining the initial value for the slot counter is less than the step value; and based on determining the initial value for the slot counter is less than the step value, using as the adjusted slot counter a value equal to the first limit value minus a difference between the step value and the initial value for the slot counter.

Clause 5: The method of any one of Clauses 2-4, wherein adjusting the slot counter based on the command and the step value comprises: determining the slot counter is initialized to a value less than the step value; and selecting a value for the adjusted slot counter equal to zero based on determining the slot counter is initialized to the value less than the step value.

Clause 6: The method of any one of Clauses 2-5, wherein adjusting the slot counter based on the command and the step value comprises: determining the slot counter is initialized to a value greater than the step value; and based on determining the slot counter is initialized to the value greater than the step value, subtracting the step value from the value for the slot counter.

Clause 7: The method of any one of Clauses 2-6, wherein the step value is predefined.

Clause 8: The method of any one of Clauses 2-7, further comprising: receiving, from the transmitter, the step value.

Clause 9: The method of any one of Clauses 1-8, wherein initializing the slot counter is further based on the scaling factor.

Clause 10: The method of Clause 9, wherein the scaling factor is based on at least one of: a priority associated with the data to be transmitted to the transmitter via the backscatter communication; or a type of the data to be transmitted to the transmitter via the backscatter communication.

Clause 11: The method of any one of Clauses 9-10, wherein initializing the slot counter comprises: randomly selecting an initial value for the slot counter from a first range of values between, and including, zero and a first limit value calculated based on the value for the slot-counter parameter and the scaling factor.

Clause 12: The method of Clause 11, wherein the step value is based on the scaling factor.

Clause 13: The method of any one of Clauses 9-12, wherein initializing the slot counter comprises: determining a first range of values between, and including, zero and a first limit value, the first limit value calculated based on the value for the slot-counter parameter; dividing the first range of values into a first set of values and a second set of values; and randomly selecting a value for the slot counter from the first set of values or the second set of values based on a type of the data.

Clause 14: The method of Clause 13, wherein the step value is based on the type of the data.

Clause 15: The method of any one of Clauses 9-14, wherein initializing the slot counter comprises: randomly selecting an initial value for the slot counter from a first range of values between, and including, zero and a first limit value calculated based on the value for the slot-counter parameter, wherein a probability of the receiver selecting the initial value for the slot counter equal to the target value is based on a priority associated with the data.

Clause 16: A method of wireless communication by a transmitter, comprising: transmitting, to a receiver, a value for a slot-counter parameter; transmitting, to the receiver, a command to adjust a slot counter initialized based on the value for the slot-counter parameter using a step value; and receiving data from the transmitter via backscatter communication when the adjusted slot counter reaches a target value, wherein at least one of: the step value is greater than one, or the slot counter is initialized further based on a scaling factor.

Clause 17: The method of Clause 16, wherein the step value is greater than one.

Clause 18: The method of Clause 17, wherein initializing the slot counter comprises: randomly selecting an initial value for the slot counter from a first range of values between, and including, zero and a first limit value calculated based on the value for the slot-counter parameter.

Clause 19: The method of any one of Clauses 17-18, wherein the step value is predefined.

Clause 20: The method of any one of Clauses 17-19, further comprising: transmitting, to the receiver, the step value.

Clause 21: The method of any one of Clauses 16-20, wherein initializing the slot counter is further based on the scaling factor.

Clause 22: The method of Clause 21, wherein the scaling factor is based on at least one of: a priority associated with the data to be received by the transmitter via the backscatter communication; or a type of the data to be received by the transmitter via the backscatter communication.

Clause 23: The method of any one of Clauses 21-22, wherein the step value is based on the scaling factor.

Clause 24: The method of any one of Clauses 21-23, wherein the step value is based on a type of the data.

Clause 25: A method of wireless communication by a receiver, comprising: receiving, from a transmitter, a command comprising information identifying at least one device to transmit data to the transmitter via backscatter communication; and transmitting the data to the transmitter via backscatter communication, when the information identifies the receiver.

Clause 26: The method of Clause 25, wherein the information identifying the at least one device comprises a portion of an identifier (ID) associated with the at least one device.

Clause 27: The method of any one of Clauses 25-26, wherein the information identifying the at least one device comprises a first value equal to a modulo function of at least a portion of an ID associated with the at least one device and a second value.

Clause 28: The method of Clause 27, wherein the information identifying the at least one device further comprises the second value.

Clause 29: The method of any one of Clauses 27-28, wherein the second value is predefined.

Clause 30: The method of any one of Clauses 27-29, wherein the information identifying the at least one device comprises an indication of a type of the at least one device.

Clause 31: The method of Clause 30, wherein the indication of the type comprises an SL flag associated with at least one device.

Clause 32: The method of any one of Clauses 25-31, wherein: the information identifies the receiver and at least one other device is to transmit the data via the backscatter communication to the transmitter; and the command further comprises a value of a slot-counter parameter.

Clause 33: The method of Clause 32, further comprising: selecting a value for a slot counter based on the value of the slot-counter parameter, wherein the transmitting the data to the transmitter is further based on the receiver selecting the value for the slot counter equal to a target value.

Clause 34: The method of any one of Clauses 32-33, wherein a value of the slot-counter parameter is based on a number of devices identified in the information.

Clause 35: A method of wireless communication by a transmitter, comprising: transmitting, to a receiver, a command comprising information identifying at least one device to transmit data via backscatter communication to the transmitter; and receiving the data from the receiver via backscatter communication, when the information identifies the receiver.

Clause 36: The method of Clause 35, wherein the information identifying the at least one device comprises a portion of an identifier (ID) associated with the at least one device.

Clause 37: The method of any one of Clauses 35-36, wherein the information identifying the at least one device comprises a first value equal to a modulo function of at least a portion of an ID associated with the at least one device and a second value.

Clause 38: The method of Clause 37, wherein the information identifying the at least one device further comprises the second value.

Clause 39: The method of any one of Clauses 37-38, wherein the second value is predefined.

Clause 40: The method of any one of Clauses 37-39, wherein the information identifying the at least one device comprises an indication of a type of the at least one device.

Clause 41: The method of Clause 40, wherein the indication of the type comprises an SL flag associated with at least one device.

Clause 42: The method of any one of Clauses 35-41, wherein: the information identifies the receiver and at least one other device is to transmit the data via the backscatter communication to the transmitter; and the command further comprises a value of a slot-counter parameter.

Clause 43: The method of Clause 42, the receiving the data from the receiver is further based on the receiver selecting the value for a slot counter, based on the value of the slot-counter parameter, equal to a target value.

Clause 44: The method of any one of Clauses 42-43, wherein the value of the slot-counter parameter is based on a number of devices identified in the information.

Clause 45: An apparatus, comprising: a memory comprising executable instructions; and a processor configured to execute the executable instructions and cause the apparatus to perform a method in accordance with any one of Clauses 1-44.

Clause 46: An apparatus, comprising means for performing a method in accordance with any one of Clauses 1-44.

Clause 47: A non-transitory computer-readable medium comprising executable instructions that, when executed by a processor of an apparatus, cause the apparatus to perform a method in accordance with any one of Clauses 1-44.

Clause 48: A computer program product embodied on a computer-readable storage medium comprising code for performing a method in accordance with any one of Clauses 1-44.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of wireless communication by a receiver, comprising:
receiving, from a transmitter, a value for a slot-counter parameter;
initializing a slot counter based on the value for the slot-counter parameter;
receiving, from the transmitter, a command to adjust the slot counter;
adjusting the slot counter based on the command and a step value; and
transmitting data to the transmitter via backscatter communication when the adjusted slot counter reaches a target value, wherein at least one of:
the step value is greater than one, or
initializing the slot counter is further based on a scaling factor.

2. The method of claim 1, wherein the step value is greater than one.

3. The method of claim 2, wherein initializing the slot counter comprises:
randomly selecting an initial value for the slot counter from a first range of values between, and including, zero and a first limit value calculated based on the value for the slot-counter parameter.

4. The method of claim 3, wherein adjusting the slot counter based on the command and the step value comprises:
determining the initial value for the slot counter is less than the step value; and
based on determining the initial value for the slot counter is less than the step value, using as the adjusted slot counter a value equal to the first limit value minus a difference between the step value and the initial value for the slot counter.

5. The method of claim 2, wherein adjusting the slot counter based on the command and the step value comprises:
determining the slot counter is initialized to a value less than the step value; and
selecting a value for the adjusted slot counter equal to zero based on determining the slot counter is initialized to the value less than the step value.

6. The method of claim 2, wherein adjusting the slot counter based on the command and the step value comprises:
determining the slot counter is initialized to a value greater than the step value; and
based on determining the slot counter is initialized to the value greater than the step value, subtracting the step value from the value for the slot counter.

7. The method of claim 2, wherein the step value is predefined.

8. The method of claim 2, further comprising:
receiving, from the transmitter, the step value.

9. The method of claim 1, wherein initializing the slot counter is further based on the scaling factor.

10. The method of claim 9, wherein the scaling factor is based on at least one of:
a priority associated with the data to be transmitted to the transmitter via the backscatter communication; or
a type of the data to be transmitted to the transmitter via the backscatter communication.

11. The method of claim 9, wherein initializing the slot counter comprises:
randomly selecting an initial value for the slot counter from a first range of values between, and including, zero and a first limit value calculated based on the value for the slot-counter parameter and the scaling factor.

12. The method of claim 11, wherein the step value is based on the scaling factor.

13. The method of claim 9, wherein initializing the slot counter comprises:
determining a first range of values between, and including, zero and a first limit value, the first limit value calculated based on the value for the slot-counter parameter;
dividing the first range of values into a first set of values and a second set of values; and
randomly selecting a value for the slot counter from the first set of values or the second set of values based on a type of the data.

14. The method of claim 13, wherein the step value is based on the type of the data.

15. The method of claim 9, wherein initializing the slot counter comprises:
randomly selecting an initial value for the slot counter from a first range of values between, and including, zero and a first limit value calculated based on the value for the slot-counter parameter, wherein a probability of the receiver selecting the initial value for the slot counter equal to the target value is based on a priority associated with the data.

16. A method of wireless communication by a transmitter, comprising:
transmitting, to a receiver, a value for a slot-counter parameter;
transmitting, to the receiver, a command to adjust a slot counter initialized based on the value for the slot-counter parameter using a step value; and
receiving data from the transmitter via backscatter communication when the adjusted slot counter reaches a target value, wherein at least one of:
the step value is greater than one, or
the slot counter is initialized further based on a scaling factor.

17. The method of claim 16, wherein the step value is greater than one.

18. The method of claim 17, wherein initializing the slot counter comprises:
randomly selecting an initial value for the slot counter from a first range of values between, and including, zero and a first limit value calculated based on the value for the slot-counter parameter.

19. A method of wireless communication by a receiver, comprising:
receiving, from a transmitter, a command comprising information identifying at least one device to transmit data to the transmitter via backscatter communication; and
transmitting the data to the transmitter via backscatter communication, when the information identifies the receiver.

20. The method of claim 19, wherein the information identifying the at least one device comprises a portion of an identifier (ID) associated with the at least one device.

21. The method of claim 19, wherein the information identifying the at least one device comprises a first value equal to a modulo function of at least a portion of an ID associated with the at least one device and a second value.

22. The method of claim 21, wherein the information identifying the at least one device further comprises the second value.

23. The method of claim 21, wherein the second value is predefined.

24. The method of claim 21, wherein the information identifying the at least one device comprises an indication of a type of the at least one device.

25. The method of claim 24, wherein the indication of the type comprises an SL flag associated with at least one device.

26. The method of claim 19, wherein:
the information identifies the receiver and at least one other device is to transmit the data via the backscatter communication to the transmitter; and
the command further comprises a value of a slot-counter parameter.

27. The method of claim 26, further comprising:
selecting a value for a slot counter based on the value of the slot-counter parameter, wherein the transmitting the data to the transmitter is further based on the receiver selecting the value for the slot counter equal to a target value.

28. The method of claim 26, wherein a value of the slot-counter parameter is based on a number of devices identified in the information.

29. A method of wireless communication by a transmitter, comprising:
transmitting, to a receiver, a command comprising information identifying at least one device to transmit data via backscatter communication to the transmitter; and
receiving the data from the receiver via backscatter communication, when the information identifies the receiver.

30. The method of claim 29, wherein the information identifying the at least one device comprises a portion of an identifier (ID) associated with the at least one device.
